(19) United States
(12) Patent Application Publication
(10) Pub. No.: US 2022/0064030 A1
(43) Pub. Date: Mar. 3, 2022

(54) DEIONIZATION FUEL CELL SYSTEM

(71) Applicant: TECHNION RESEARCH & DEVELOPMENT FOUNDATION LIMITED, Haifa (IL)

(72) Inventors: Matthew SUSS, Nesher (IL); Shada ABU KHALLA, Julis (IL); Yair KORENBLIT, Haifa (IL)

(21) Appl. No.: 17/414,460

(22) PCT Filed: Dec. 18, 2019
(86) PCT No.: PCT/IL2019/051381

§ 371 Date: Jun. 16, 2021

Related U.S. Application Data
(60) Provisional application No. 62/780,931, filed on Dec. 18, 2018.

(51) Int. Cl. C02F 1/469; H01M 8/08; H01M 8/22; C02F 1/461; B01D 61/46

(52) U.S. Cl. CPC C02F 1/4693; H01M 8/08; H01M 2008/1095; C02F 1/46104; B01D 61/46; H01M 8/227

(57) ABSTRACT

The present invention provides a method of deionization of a liquid including passing feedwater to be deionized through a deionization fuel cell system, which includes a deionization fuel cell (DFC), containing, inter alia, a cation exchange membrane and an anion exchange membrane and discharging the DFC to produce electricity and deionized liquid, wherein the method does not include a step of charging the fuel cell prior to or following the discharge step. Further provided are deionization fuel cell systems comprising a DFC comprising two or more membranes.

### FIELD OF THE INVENTION

The present invention is directed to deionization fuel cell systems comprising a fuel cell comprising at least two ion exchange membranes and methods of deionization of a liquid comprising passing a feedwater through said deionization fuel cell system.

### BACKGROUND OF THE INVENTION

Several countries around the world have operating city-scale water deionization systems, with the most utilized technology being sea water reverse osmosis (SWRO). Such SWRO plants deliver on the order of 10 million m³ of treated water per day, and require pressurizing a feedwater above its osmotic pressure (about 25 bar) in order to drive pure water through a semi-permeable membrane that rejects salts. As water scarcity increasingly affects more diverse locales, the requirements of a technological solution to combat scarcity are becoming more diverse, and technologies with novel functionalities should be explored. While highly successful to date, SWRO is limited by poor down-scalability as a result of the high pressures required, enormous capital costs of city-scale SWRO plants, and the high electricity requirements to drive the high-pressure pumps and the pre-treatment processes needed to protect the RO membrane.

Many alternatives to RO have been investigated. Electrodialysis (ED) is an electrochemical system employing alternating anion and cation exchange membranes, and has been investigated for several decades as a desalination technology. In an ED cell, electricity is applied to drive salt ion transport from a diluate channel into an adjacent brine channel. While ED cells are highly scalable and can desalinate at low (sub-osmotic) pressures, they are not as energy efficient as RO when performing sea water desalination.

In recent years, there has been a surge of interest in emerging electrochemical systems towards water desalination, such as capacitive deionization (CDI), desalination batteries, and desalination redox flow batteries. Unlike ED, said electrochemical systems are generally adapted from energy storage cells, and operate in a cyclic fashion by undergoing charge/discharge cycling. Generally, desalination occurs during cell charging, and during discharging brine is created and electrical energy can be recovered. Like energy storage systems, such cells are net users of electricity over a full charge/discharge cycle, although the electrical energy requirements for such systems have shown significant promise relative to ED and RO for brackish water desalination (T. Kim, C. A. Gorski and B. E. Logan, Environ. Sci. Technol. Lett., 2017, 4, 444-449; R. Zhao, S. Porada, P. M. Biesheuvel and A. Van der Wal, Desalination, 2013, 330, 35-41).

It has been shown recently that certain desalination cells can desalinate during discharge, in a so-called inverted mode of operation. For example, Gao et al., demonstrated a CDI system using an oxidized anode with net negative surface charges and a cathode with net positive surface charges, in which salt separation is achieved in an opposing manner to the conventional CDI system (X. Gao, A. Omosebi, J. Landon and K. Liu, Energy Environ. Sci., 2015, 8, 897-909). Desai et al., developed a zinc/ferricyanide hybrid flow battery that achieves extensive first-pass desalination while simultaneously supplying electrical energy (10 Wh/L) (D. Desai, E. S. Beh, S. Sahu, V. Vedharathinam, Q. Van Overmeere, C. F. De Lannoy, A. P. Jose, A. R. Völkel and J. B. Rivest, ACS Energy Lett., 2018, 3, 375-379). A double-function system of faradaic desalination and a redox flow battery consisting of VCl3|NaI redox flow electrodes and a feed stream was also presented (S. H. Xianhua Hou, Qian Liang, Xiaoqiao Hu, Yu Zhou, Qiang Ru, Fuming Chen, Nanoscale, 2018, 10, 12308-12314). The system has a nominal cell potential, wherein during the discharge process, the salt ions in the feed are extracted by the redox reaction of the flow electrodes, which is indicated by salt removal.

However, rechargeable desalination cells still depend on the charging step to perform subsequent discharge cycles, and are thus net users of electricity. Additionally, CDI and desalination batteries, which desalinate via two-stage charge/discharge processes, have limited salt storage capacity. When electrochemical systems which provide desalination simultaneously with producing electricity are employed, during subsequent charging step salt ions are driven back to the feedwater. Accordingly, the body of water which had been deionized during the discharge step should be removed and replaced with a new volume of feedwater prior to subsequent charge. For seawater desalination by reverse osmosis, the cost of the desalted water is typically between $0.5/kWh-$1/kWh, and thus novel technologies, such as CDI and desalination batteries, should strive to deliver water at equal or lower cost.

There remains, therefore, an unmet need for low-cost, energy efficient and power grid-independent deionization systems, which would provide continuous desalination without interruption or capacity limitations.

### SUMMARY OF THE INVENTION

The present invention provides a deionization fuel cell system and a method of deionization of a liquid, which are based solely on a chemical-to-electrical energy conversion. Such system and method do not require electricity input before, after or during the deionization process. The deionization fuel cell system comprises a deionization fuel cell (DFC) which, in contrast to conventional fuel cells, incorporates two or more membranes, including a cation exchange membrane (CEM) and an anion exchange membrane (AEM). The anion exchange membrane and the cation exchange membrane form a flow channel therebetween for the flow of feedwater. Two additional flow channels can be formed between the cathode and the cation exchange membrane and the anode and the anion exchange membrane, for the flow of a catholyte and an anolyte, respectively. Additional membranes can be used, depending on the charge of the DFC reactants.

The present invention is based in part on a surprising finding that the DFC can operate in galvanic mode, simultaneously delivering electricity, wherein the deionization process is continuous and is not interrupted by charging steps and/or deionized water removal. Accordingly, large volumes of water and/or highly concentrated solutions can be deionized in a single-step deionization process to provide total dissolved solids (TDS) values acceptable in agricultural applications or even in drinking water. At least one of the anolyte and catholyte is stored outside the DFC and the amount of the redox active species, which can be present in the anolyte and the catholyte is sufficient to enable said single-step deionization process.

It has further been unexpectedly discovered that positively charged oxidant and negatively charged reductant can be flown through the catholyte and anolyte flow channels, respectively, despite the potential diffusion of said ions through their adjacent CEM and AEM to the feedwater flow channel. The operational conditions of the DFC have been regulated to minimize the potential diffusion and the oxidant and the reductant have been chosen such that they react in the feedwater flow channel to produce a neutral non-ionic compound. In particular, hydrogen-oxygen and acid-base DFCs have been constructed using said inventive principle, in which the reaction product is water, which can only decrease concentration of ions in the feedwater flow channel.

The DFC system and deionization method according to the principles of the present invention are not limited by anolyte and catholyte energy storage capacity. Advantageously, the DFC can be re-fueled, allowing for continuous deionization without interruption or capacity limitations.

Thus, in one aspect, there is provided a method of deionization of a liquid, the method comprising: passing feedwater to be deionized through a deionization fuel cell system comprising a deionization fuel cell (DFC) comprising a cathode; an anode; and at least: a first cation exchange membrane (CEM); and a first anion exchange membrane (AEM), and discharging the DFC to produce electricity and deionized liquid, wherein the method does not include a step of charging the fuel cell prior to or following the discharge step.

According to some embodiments, the DFC is discharged at a current density of at least about 1 mA/cm². According to further embodiments, the DFC is discharged until dissolved solids (TDS) content of the feedwater is reduced to below about 3000 parts per million (ppm). In still further embodiments, the TDS content of the feedwater prior to the discharge step is at least about 15 parts-per-thousand (ppt).

According to some embodiments, the DFC comprises a catholyte flow channel, being disposed adjacent to the cathode; an anolyte flow channel, being disposed adjacent to the anode; and a feedwater flow channel formed between the first CEM and the first AEM.

In some general embodiments, the DFC comprises:
(n) CEMs and (n) AEMs, which form (2n−1) feedwater flow channels; or
(n) CEMs and (n+1) AEMs, which form (2n) feedwater flow channels; or
(n+1) CEMs and (n) AEMs, which form (2n) feedwater flow channels,
wherein (n≥1).

According to some embodiments, the step of passing the feedwater through the deionization fuel cell system comprises passing the feedwater through the feedwater flow channels. The method can further include a step of passing a catholyte through the catholyte flow channel and/or passing an anolyte through the anolyte flow channel. The steps of passing the catholyte through the catholyte flow channel, passing the anolyte through the anolyte flow channel, and passing the feedwater through the feedwater flow channel can be done simultaneously. In some related embodiments, the feedwater is continuously cycled through the feedwater flow channel, the catholyte is continuously cycled through the catholyte flow channel and the anolyte is continuously cycled through the anolyte flow channel. In certain embodiments, the flow rate of the catholyte and/or anolyte is at least two-fold higher than the flow rate of the feedwater.

According to the various embodiments of the invention, the catholyte comprises an oxidant and/or its reduction reaction product. According to additional embodiments, the anolyte comprises a reductant and/or its oxidation reaction product.

According to some embodiments, the fuel cell system further comprises at least one of a catholyte tank, which is operatively connected to the catholyte flow channel and an anolyte tank, which is operatively connected to the anolyte flow channel. In further embodiments, the method comprises filling at least one of the catholyte tank and the anolyte tank with the catholyte and the anolyte, respectively, prior to the discharge step.

According to some embodiments, the fuel cell system further comprises a feedwater tank, which is operatively connected to the feedwater flow channel.

According to some embodiments, the method does not include a step of producing the oxidant and/or reductant within the deionization fuel cell system. According to further embodiments, the method does not include a step of producing the oxidant and/or reductant within the deionization fuel cell system by charging the DFC.

According to some embodiments, the oxidant and/or the reductant is present in the catholyte and/or the anolyte in an amount configured to allow reduction of the TDS content of the feedwater to below about 3000 ppm. In further embodiments, the oxidant and/or the reductant is present in the catholyte and/or anolyte in an amount configured to allow reduction of the TDS content of the feedwater to below about 3000 ppm without the need to add a new portion of said oxidant and/or said reductant to the catholyte and/or anolyte during the discharge step.

According to some embodiments, the method further comprises a step of adding a new portion of the oxidant to the catholyte and/or a new portion of the reductant to the anolyte following the discharge step.

The catholyte can comprise cations which are the same as the cations contained in the feedwater. In some embodiments, the anolyte comprises anions which are the same as the anions contained in the feedwater.

The reductant can be selected from the group consisting of zinc, sulfur, hydrogen, hydroxyl ion, and vanadium. The oxidant can be selected from the group consisting of bromide, iodide, oxygen, air, and iron. In some related embodiments, the DFC is selected from the group consisting of zinc-bromine fuel cell, air-breathing aqueous sulfur fuel cell, oxygen-sulfur fuel cell, iron-sulfur fuel cell, hydrogen-oxygen fuel cell, acid-base fuel cell, and iodine-vanadium fuel cell. Each possibility represents a separate embodiment of the invention.

In some exemplary embodiments, the DFC is a zinc-bromine fuel cell. In further embodiments, the catholyte is an aqueous solution comprising tribromide and sodium cations. In still further embodiments, the concentration of tribromide ranges from about 0.5 M to about 3 M. In yet further embodiments, the catholyte tank comprises at least about 0.5 liter of the catholyte. In still further embodiments, the anolyte is an aqueous solution comprising zinc cations and chloride anions.

According to some embodiments, the DFC is a hydrogen-oxygen fuel cell or an acid-base fuel cell. Each possibility represents a separate embodiment of the invention. According to further embodiments, the catholyte is an aqueous solution comprising HCl and NaCl and the anolyte is an aqueous solution comprising NaOH and NaCl.

The feedwater can be selected from the group consisting of seawater, brackish water, hard water, wastewater and organic streams needing remediation. Each possibility represents a separate embodiment of the invention.

According to some embodiments, the feedwater comprises uncharged species. According to further embodiments, the method further comprises a step of inputting energy into the DFC system to ionize and/or radicalize said uncharged species in the feedwater, wherein said step is performed by applying to the DFC at least one of a high voltage, heat, sonication, and electromagnetic radiation. Each possibility represents a separate embodiment of the invention.

According to another aspect, there is provided a deionization fuel cell system, comprising: (a) a deionization fuel cell (DFC) comprising: a cathode; an anode; a catholyte flow channel; an anolyte flow channel, and at least: a first cation exchange membrane (CEM); a first anion exchange membrane (AEM), and a first feedwater flow channel, wherein the catholyte flow channel is disposed adjacent to the cathode, the anolyte flow channel is disposed adjacent to the anode, and the first feedwater flow channel is formed between the first CEM and the first AEM and is configured for feedwater deionization, and (b) at least one of a catholyte tank and an anolyte tank, the catholyte tank being operatively connected to the catholyte flow channel and the anolyte tank being operatively connected to the anolyte flow channel, and the catholyte tank comprises a catholyte comprising an oxidant and/or its reduction reaction product and/or the anolyte tank comprises an anolyte comprising a reductant and/or its oxidation reaction product, wherein said oxidant and/or said reductant is present in the catholyte and/or the anolyte, respectively, in an amount configured to allow reduction of the total dissolved solids (TDS) content of the feedwater to below about 3000 parts-per-million (ppm), wherein the fuel cell operates entirely in a discharge mode.

According to some embodiments, the deionization fuel cell system further comprises a feedwater tank being operatively connected to the first feedwater flow channel, wherein the feedwater tank comprises feedwater to be deionized.

According to some general embodiments, the DFC comprises:
(n) CEMs and (n) AEMs, which form (2n−1) feedwater flow channels; or
(n) CEMs and (n+1) AEMs, which form (2n) feedwater flow channels; or
(n+1) CEMs and (n) AEMs, which form (2n) feedwater flow channels,

wherein (n≥1).

According to some embodiments, the catholyte flow channel is formed between the cathode and the first CEM and the anolyte flow channel is formed between the first AEM and the anode. According to some related embodiments, the oxidant is neutral or negatively charged and/or its reduction reaction product is negatively charged. According to further embodiments, the reductant is neutral or positively charged and/or its oxidation reaction product is positively charged.

The DFC can further comprise a second CEM and a second feedwater flow channel, wherein the catholyte flow channel is formed between the cathode and the first CEM; the anolyte flow channel is formed between the second CEM and the anode; and the second feedwater flow channel is formed between the first AEM and the second CEM. In some related embodiments, the oxidant is neutral or negatively charged and/or its reduction reaction product is negatively charged. In further embodiments, the reductant is negatively charged and/or its oxidation reaction product is neutral or negatively charged.

According to some embodiments, the DFC further comprises a second CEM, a second AEM, a second feedwater flow channel, and a third feedwater flow channel, wherein the catholyte flow channel is formed between the cathode and the second AEM; the anolyte flow channel is formed between the second CEM and the anode; the second feedwater flow channel is formed between the first AEM and the second CEM; and the third feedwater flow channel is formed between the first CEM and the second AEM. According to some related embodiments, the oxidant is positively charged and/or its reduction reaction product is neutral or positively charged. In further embodiments, the reductant is negatively charged and/or its oxidation reaction product is neutral or negatively charged.

According to some embodiments, the first feedwater flow channel is configured to deionize the feedwater. According to further embodiments, the second feedwater flow channel, the third feedwater flow channel or both are configured to concentrate the feedwater. In certain embodiments, the system further comprises a brine tank being operatively connected to the second feedwater flow channel, the third feedwater flow channel or both. The system can further comprise a deionized liquid tank operatively connected to the first feedwater flow channel.

According to some currently preferred embodiments, the DFC does not require electricity input to provide said reduction of the TDS to below about 3000 ppm. In some related embodiments, the TDS content of the feedwater prior to the operation of the DFC is at least about 15 ppt.

According to some embodiments, the chemical composition of the catholyte is different from the composition of the anolyte. In further embodiments, the catholyte comprises cations which are the same as the cations contained in the feedwater. In still further embodiments, the anolyte comprises anions which are the same as the anions contained in the feedwater.

The cathode and/or the anode can be selected from the group consisting of graphite, carbon, metal, metal carbide, metal nitride, metal oxide, polymer, and any combination thereof. Each possibility represents a separate embodiment of the invention.

The first AEM, the second AEM, the first CEM, the second CEM, or any combination thereof can be selected from the group consisting of an ion-selective polymeric membrane, ion-selective ceramic separator, ion-selective zeolite separator, and ion-selective glass separator. Each possibility represents a separate embodiment of the invention. In some embodiments, the first and/or the second AEM is selected from the group consisting of non-alkaline anion exchange membrane, alkaline anion exchange membrane (AAEM), hydroxide-exchange membrane (HEM), anion-exchange ionomer membrane (AEI), and combinations thereof. In additional embodiments, the first and/or the second CEM is selected from the group consisting of non-acidic cation exchange membrane, proton-exchange membrane (PEM), cation-exchange ionomer membrane, and combinations thereof.

The reductant can be selected from the group consisting of zinc, sulfur, hydrogen, and vanadium. The oxidant can be selected from the group consisting of bromine, iodine, oxygen, air, and iron. In some related embodiments, the DFC is selected from the group consisting of zinc-bromine fuel cell, air-breathing aqueous sulfur fuel cell, oxygen-sulfur fuel cell, iron-sulfur fuel cell, hydrogen-oxygen fuel cell, and iodine-vanadium fuel cell. Each possibility represents a separate embodiment of the invention.

In some exemplary embodiments, the DFC is a zinc-bromine fuel cell. In further embodiments, the catholyte is an aqueous solution comprising tribromide and sodium cations. In still further embodiments, the concentration of tribromide ranges from about 0.5 M to about 3 M. In yet further embodiments, the catholyte tank comprises at least about 0.5 liter of the catholyte.

According to some embodiments, the DFC further comprises a gasket or a spacer disposed between the respective CEMs, AEMs, cathode, and anode, thereby forming the feedwater, anolyte and catholyte flow channels.

According to some embodiments, the fuel cell further comprises a first current collector disposed adjacent to the cathode and a second current collector disposed adjacent to the anode.

According to some embodiments, the system further comprises at least a first pump configured to deliver the feedwater to the first, second and/or third feedwater flow channel and a second pump configured to deliver the catholyte to the catholyte flow channel and/or the anolyte to the anolyte flow channel.

In another aspect, there is provided a deionization fuel cell system, comprising:

(a) a deionization fuel cell (DFC) comprising: a cathode; an anode; a catholyte flow channel; an anolyte flow channel, a cation exchange membrane (CEM); an anion exchange membrane (AEM), and a feedwater flow channel, wherein the catholyte flow channel is disposed between the cathode and the CEM, the anolyte flow channel is disposed between the anode and the AEM, and the feedwater flow channel is disposed between the CEM and the AEM, and

(b) a catholyte tank being operatively connected to the catholyte flow channel and an anolyte tank being operatively connected to the anolyte flow channel, wherein the catholyte tank comprises a catholyte comprising an oxidant comprising hydronium ions and the anolyte tank comprises an anolyte comprising a reductant comprising hydroxyl ions.

According to some embodiments, the deionization fuel cell system further comprises a feedwater tank being operatively connected to the feedwater flow channel.

According to some embodiments, the DFC is a hydrogen-oxygen DFC, wherein the oxidant further comprises oxygen gas being supplied to the cathode and the reductant further comprises hydrogen gas being supplied to the anode.

According to some embodiments, the DFC is an acid-base DFC, wherein the oxidant further comprises oxygen gas being supplied to the cathode.

According to some embodiments, the catholyte is an aqueous solution comprising HCl and an alkali metal or alkaline earth metal salt and the anolyte is an aqueous solution comprising NaOH and an alkali metal or alkaline earth metal salt. According to further embodiments, the concentration of HCl in the catholyte ranges from about 0.1 mM to about 0.5 M, the concentration of NaOH in the anolyte ranges from about 0.1 mM to about 0.5 M, and the concentration of the alkali metal or alkaline earth metal salt is at least about 5 times higher than the concentration of each of the HCl and NaOH.

According to some embodiments, the cathode and the anode comprise a gas diffusion layer and a catalytic layer comprising a noble metal catalyst.

In another aspect, there is provided a method of deionization of a liquid, the method comprising:

(a) passing feedwater to be deionized through a deionization fuel cell system comprising: a cathode; an anode; a catholyte flow channel, an anolyte flow channel, a cation exchange membrane (CEM); an anion exchange membrane (AEM), and a feedwater flow channel, wherein: the catholyte flow channel is disposed between the cathode and the CEM, the anolyte flow channel is disposed between the anode and the AEM, and the feedwater flow channel is disposed between the CEM and the AEM, and a catholyte tank being operatively connected to the catholyte flow channel, and an anolyte tank being operatively connected to the anolyte flow channel, wherein the catholyte tank comprises a catholyte comprising an oxidant comprising hydronium ions and the anolyte tank comprises an anolyte comprising a reductant comprising hydroxyl ions. The method of deionization of a liquid further comprises:

(b) flowing oxygen gas to the cathode, and, optionally, flowing hydrogen gas to the anode, and

(c) discharging the DFC to produce electricity and deionized liquid.

Preferably, steps (a), (b), and (c) are being performed simultaneously.

According to some embodiments, step (a) comprises continuously cycling the feedwater through the first feedwater flow channel. According to further embodiments, step (a) further comprises continuously cycling the catholyte through the catholyte flow channel and continuously cycling the anolyte through the anolyte flow channel.

The feedwater can be selected from the group consisting of seawater, brackish water, hard water, wastewater and organic streams needing remediation. Each possibility represents a separate embodiment of the present invention.

According to some currently preferred embodiments, the method of deionization does not include a step of charging the DFC prior to or following the discharge step.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1: Schematic representation of the deionization fuel cell system, wherein both the anolyte and the catholyte are stored outside the DFC, in accordance with some embodiments of the invention.

FIG. 2: Schematic representation of the deionization fuel cell system, wherein the catholyte is stored outside the DFC, in accordance with some embodiments of the invention.

FIG. 3A: Schematic representation of the DFC comprising a positively charged reductant and a negatively charged oxidant, in accordance with some embodiments of the invention.

FIG. 3B: Schematic representation of the DFC comprising a negatively charged reductant and a negatively charged oxidant, in accordance with some embodiments of the invention.

FIG. 3C: Schematic representation of the DFC comprising a negatively charged reductant and a positively charged oxidant, in accordance with some embodiments of the invention.

FIG. 4: Photograph of the experimental DFC with 10 cm² active area.

FIG. 5A: A polarization curve showing measured equilibrium cell voltage of the DFC versus extracted current.

FIG. 5B: Measured DFC voltage during constant current experiments at various currents from 2 to 16 mA/cm².

FIG. 5C: Measured feedwater flow channel effluent concentration and cumulative energy production by the DFC during the experiment at 2 mA/cm² shown in FIG. 5B.

FIG. 5D: Measured feedwater flow channel effluent concentration and cumulative energy production by the DFC during the experiment at 16 mA/cm² shown in FIG. 5B.

FIG. 5E: Measured feedwater flow channel effluent concentration and cumulative energy production by the DFC during deionization of 1.5M NaCl at 16 mA/cm².

FIG. 6: Measured energy recovery efficiency (left axis, circles) and deionization efficiency (right axis, triangles) versus extracted current density, obtained with the DFC, wherein recovery efficiency is defined as the ratio of electricity recovered during deionization to input energy, and deionization efficiency is the ratio of utilized energy during deionization to the minimum thermodynamic energy needed to perform the deionization process.

FIG. 7: Evaluation of the cost of reactants for the DFC, in units of $ per m³ of desalted feedwater. The dashed line shows the calculated revenue from the electricity production of the experimental DFC shown in FIG. 4.

FIG. 8: Schematic representation of the oxygen-hydrogen DFC, in accordance with some embodiments of the invention.

FIG. 9: Polarization curve showing measured equilibrium cell voltage (squares) and concentration of effluent leaving the desalination channel (diamonds) normalized by the initial concentration of the feedwater (500 mM NaCl) of the hydrogen-oxygen DFC versus extracted current density.

FIG. 10: Schematic representation of the oxygen-hydrogen DFC, in accordance with some embodiments of the invention.

### DETAILED DESCRIPTION OF THE INVENTION

The present invention provides a deionization fuel cell system and a method of deionization of a liquid, e.g., water, which are based solely on a chemical-to-electrical energy conversion and do not require electricity input (or any other type of energy) before, after or during the deionization process. Deionization is performed simultaneously with producing electricity, the deionization process thus being exceptionally energy efficient and power grid-independent. Inventors of the present invention have demonstrated a DFC system which can desalinate water with an initial salinity approximately that of sea water without requiring any electricity input, instead generating electricity during the deionization process.

The DFC system and deionization method according to the principles of the present invention are based on a redox reaction between an oxidant and a reductant, which are supplied to the DFC in an amount sufficient for producing water having TDS of below about 3000 ppm in a single-discharge step. The zinc-bromine DFC-based system, according to the principles of the present invention, demonstrated electricity production of up to 23.5 kWh/m³ of desalted water while desalinating a feed of about 30 g/L NaCl to near-zero concentration. Since no charging step is required, production of the redox active species suitable for use in the DFC (i.e., the oxidant and reductant) can be decoupled from their use in the DFC. Such decoupling can provide cost advantages, as such redox active chemicals can be produced via more cost-effective processes than redox half-cell reactions, such as, for example, reforming and chemical synthesis. It has further been shown that using low-cost reactants such as sulfur and oxygen in the deionization system and method of the present invention can potentially provide ultra-low cost desalted seawater, with operational costs well below $0.5/m³.

Further provided is a deionization system, comprising a DFC having a two-membrane design, in which the catholyte comprises a positively charged oxidant (e.g., hydronium ions) and the anolyte comprises a negatively charged reductant (e.g., hydroxyl ions). Surprisingly, such system provided efficient water deionization despite potential flow of the oxidant and the reductant through the CEM and the AEM, respectively. In the hydrogen-oxygen DFC, for example, the crossover of hydronium ions and hydroxyl ions can be minimized by controlling experimental conditions, inter alia, by using low concentrations of said ions as compared to the total ionic concentration of the catholyte and anolyte. Additionally, even if hydroxyl and hydronium ions were to pass through their respective membranes to the feedwater flow channel, they would undergo a neutralization reaction, and therefore would not increase the ionic concentration of the feedwater to be deionized.

Thus, in one aspect there is provided a deionization fuel cell system comprising a deionization fuel cell which comprises a cathode, an anode, and at least a first cation exchange membrane, and a first anion exchange membrane.

In another aspect, there is provided a method of deionization of a liquid comprising passing feedwater to be deionized through said deionization fuel cell system, and discharging the fuel cell to produce electricity and deionized liquid, wherein the method does not require a step of charging the DFC prior to or following the discharge step.

The terms “deionize” and desalinate” are used interchangeably and refer to the reduction in the TDS content of the feedwater.

The term “fuel cell”, as used herein, refers in some embodiments to an electrochemical cell that converts chemical energy into electricity through an electrochemical reaction between redox active species, which include a reductant and an oxidant, wherein at least one of the reductant and the oxidant is stored outside the electrochemical cell, for example in a storage tank. In some embodiments, the oxidant and/or the reductant is continuously supplied to the DFC during the electrochemical operation thereof. The term “fuel cell” is also meant to encompass redox flow batteries.

In some embodiments, the oxidant is stored outside the DFC and is continuously supplied to the DFC during the electrochemical operation thereof. In some embodiments, the oxidant is freely supplied to the DFC from the surrounding atmosphere. In some embodiments, the reductant is stored outside the DFC and is continuously supplied to the DFC during the electrochemical operation thereof.

In some embodiments, the reductant is stored within the DFC, for example, in form of a solid electrode or being intercalated into the electrode. In alternative embodiments, the reductant is stored outside the DFC and is continuously supplied to the DFC during the electrochemical operation thereof.

The term “electrochemical operation”, as used herein, refers in some embodiments, to the operation of the system or the DFC, wherein the voltage between the anode and the cathode in the DFC is different than the open circuit voltage (OCV). In particular embodiments, said electrochemical operation comprises discharging the DFC.

According to some embodiments, the cathode and the anode are connected via an external electric circuit. In further embodiments, said electric circuit comprises an electric load. Said load can be configured to draw electricity from the DFC. In some embodiments, the DFC is connected to an operating system through said electric circuit, which allows controlling potential applied or established between the anode and the cathode or an electric current drawn from the DFC. For example, pumps, which flow the feedwater, anolyte, and/or catholyte through the DFC can draw electricity from said electric circuit. In certain such embodiments, the system is operated by electricity, which it produces.

In some aspects and embodiments, the first anion exchange membrane and the first cation exchange membrane form a flow channel therebetween for the flow of feedwater. Said feedwater flow channel formed between the first AEM and the first CEM is termed herein “first feedwater flow channel”. Additional flow channels can be formed between the cathode and the first cation exchange membrane, and/or between the anode and the first anion exchange membrane. The flow channel formed between the cathode and the first CEM is configured for the flow of a catholyte. The flow channel formed between the anode and the first AEM is configured for the flow of an anolyte.

The term “anolyte”, as used herein, refers to a fluid being in contact with the anode during the DFC electrochemical operation and comprising a reductant, a product of the oxidation reaction of the reductant, or both. The term “reductant”, as used herein, is meant to encompass a single reactant, which reacts at the anode by changing an oxidation state of at least one of its atoms, to produce the oxidation reaction product, as well as, a combination of two or more reactants, which react at the anode to produce the oxidation reaction product, which is a chemical compound held together by covalent bonds, wherein only one of the reactants changes its oxidation state and the oxidation state of the other reactants remain unchanged. For example, in a hydrogen-oxygen DFC, the reductant comprises a combination of hydrogen gas (H₂) and hydroxyl ions (OH⁻), which form water at the anode, wherein the oxidation state of hydrogen atoms in the hydrogen gas changes in the course of the oxidation reaction and the oxidation state of oxygen and hydrogen atoms of the hydroxyl ions remains unchanged.

The term “catholyte”, as used herein, refers to a fluid being in contact with the cathode during the DFC electrochemical operation and comprising an oxidant, a product of the reduction reaction of the oxidant, or both. The term “oxidant”, as used herein, is meant to encompass a single reactant, which reacts at the cathode by changing an oxidation state of at least one of its atoms, to produce the reduction reaction product, as well as, a combination of two or more reactants, which react at the cathode to produce the reduction reaction product, which is a chemical compound held together by covalent bonds, wherein only one of the reactants changes its oxidation state and the oxidation state of the other reactants remain unchanged. For example, in a hydrogen-oxygen DFC, the oxidant comprises a combination of oxygen gas (O₂) and protons (H⁺), which form water at the cathode, wherein the oxidation state of oxygen atoms in the oxygen gas change in the course of the reduction reaction and the oxidation state of hydrogen atoms of the protons remains unchanged. The term “product”, as used herein, is meant to encompass final product of the reduction or oxidation reactions, as well, as intermediate products and by-products of said reactions.

The anolyte, the catholyte or both can contain dissolved gaseous species, such as, for example, oxygen or hydrogen gas.

The DFC according to the principles of the present invention should include at least one of a catholyte flow channel and an anolyte flow channel for the flow of the oxidant and/or the reductant, respectively. In some embodiments, the DFC comprises a catholyte flow channel for the flow of a catholyte comprising an oxidant. In certain such embodiments, the catholyte flow channel is disposed adjacent to the cathode.

The reductant can be stored within the DFC, as explained above. In certain such embodiments, the DFC can further include an anolyte flow channel for the flow of an anolyte comprising a reductant oxidation reaction product. In other embodiments, the DFC comprises an anolyte flow channel for the flow of an anolyte comprising a reductant. In further embodiments, the anolyte flow channel is disposed adjacent to the anode.

According to some embodiments, before electrochemical operation of the DFC, the anolyte flow channel is filled by flowing or stagnant anolyte. In some embodiments, the catholyte flow channel is filled by flowing or stagnant catholyte, before electrochemical operation of the DFC. In additional embodiments, the first feedwater flow channel is filled by flowing feedwater to be deionized, before electrochemical operation of the DFC.

The flow channels of the present DFC can have an inlet and an outlet.

The anolyte and/or the catholyte can be stored in the deionization fuel cell system in storage tanks and supplied to the respective flow channels of the DFC before and/or during the electrochemical operation thereof. Accordingly, in some aspects and embodiments, said storage tanks are being operatively connected to the catholyte flow channel and/or the anolyte flow channel. The storage tank containing the anolyte is also termed herein “anolyte tank” or “anolyte storage tank” and the storage tank containing the catholyte is also termed herein “catholyte tank” or “catholyte storage tank”. In certain embodiments, the catholyte storage tank is in fluid-flow connection with the catholyte flow channel. In additional embodiments, the anolyte storage tank is in fluid-flow connection with the anolyte flow channel.

Feedwater can be provided in a storage tank, also termed herein “feedwater tank”, being in fluid-flow connection with the feedwater flow channel. The term “feedwater tank” is meant to encompass artificial storage tanks, as well as embodiments, in which the deionization fuel cell system (and in particular its feedwater flow channel) is fluidly connected to a natural feedwater source, including any type of a liquid-containing reservoir, e.g., sea.

The anolyte, the catholyte, and/or the feedwater can be continuously cycled through the respective flow channels and storage tanks during the electrochemical operation of the DFC. The term “continuous circulation”, as used herein, refers in some embodiments to continuous flow of a liquid without the need to suspend the flow and is meant to encompass close-loop, and well as, open-loop circulation. Circulation of the anolyte, catholyte, and/or feedwater can be carried out by one or more pumps. The deionized liquid (following passing through the DFC during its operation) can be stored in a separate storage tank, also termed herein “deionized liquid tank”. In further embodiments, the feedwater is passed from the storage tank to the first feedwater flow channel through the flow channel inlet and is then passed from the first feedwater flow channel to the deionized liquid tank through the flow channel outlet. The term “continuous circulation”, as used in connection with the feedwaters, is therefore meant to encompass continuous flow of the feedwater without the need to suspend its flow, wherein the feedwater can flow from the feedwater tank to the feedwater flow channel and from the feedwater flow channel back to the feedwater tank or flow from the feedwater tank to the feedwater flow channel and from the feedwater flow channel to the deionized liquid tank. The term “deionized liquid tank” is meant to encompass artificial storage tanks, as well as embodiments, in which the deionization fuel cell system (and in particular its feedwater flow channel) is fluidly connected to a water supply system.

According to some embodiments, the catholyte storage tank comprises at least about 0.5 liter of the catholyte. In further embodiments, the catholyte storage tank comprises at least about 1 liter of the catholyte, at least about 2 liter, at least about 5 liter, at least about 10 liter, at least about 20 liter, or at least about 50 liter of the catholyte. According to some embodiments, the anolyte storage tank comprises at least about 0.5 liter the anolyte. In further embodiments, the anolyte storage tank comprises at least about 1 liter of the anolyte, at least about 2 liter, at least about 5 liter, at least about 10 liter, at least about 20 liter, or at least about 50 liter of the anolyte. Each possibility represents a separate embodiment of the invention.

Alternatively, the anolyte or the catholyte is not stored in a storage tank. In certain such embodiments, the flow channel formed between the anode and the AEM or the flow channel formed between the cathode and the CEM is also termed “anolyte compartment” or “catholyte compartment”, respectively. In additional embodiments, the reductant or the oxidant is not stored in a storage tank but rather is supplied to the DFC from the surrounding atmosphere or from a gas. The reductant and/or the oxidant can be supplied to the DFC through the anode and/or the cathode, respectively.

The deionization process is based on the redox reaction of the oxidant, which can be present in the catholyte and the reductant, which can be present in the anolyte. During operation of the DFC, the half-cell reactions of the oxidant and the reductant induce electrical current in the external electric circuit connecting the cathode and the anode and also give rise to a spontaneous ionic current between the cathode and the anode within the cell. Without wishing to being bound by theory or mechanism of action, said ionic current drives ion removal from the feedwater flowing in the feedwater flow channel. When the reductant and the oxidant are not charged, formation of their redox reaction products during cell operation increases the overall positive charge in the anolyte flow channel and the overall negative charge in the catholyte flow channel. In certain such embodiments, the positively charged ions migrate from the feedwater flow channel to the catholyte flow channel and negatively charged ions migrate to the anolyte flow channel, to balance the charge differences across the cell.

The deionization fuel cell system and method of feedwater deionization of the present invention are based on a surprising finding that the entire deionization process can be performed without application of electrical energy. Said continuous and off-grid deionization process is enabled by adjusting the amounts of the reductant and the oxidant in the system. In particular, at least one of the oxidant and the reductant should be present in the system in a sufficient amount to provide single-step deionization. The term “single-step deionization” refers in some embodiments, to the reduction of the total dissolved solids (TDS) content of the feedwater to below about 3000 parts per million (ppm), performed during a single discharge step of the DFC. Accordingly, in some embodiments, the total weight or volume of the oxidant and/or reductant, which is present in the system, allows reduction of the total dissolved solids (TDS) content of the feedwater to below about 3000 parts per million (ppm), wherein the DFC operates entirely in a discharge mode. In further embodiments, the total weight or volume of the oxidant and/or reductant, which is present in the system, allows reduction of the TDS content of the feedwater to below about 2000 ppm, below about 1000 ppm, or below about 500 ppm. Each possibility represents a separate embodiment of the invention. According to further embodiments, the DFC does not require electricity input to provide said reduction of the TDS.

In certain embodiments, the DFC provides continuous deionization of the feedwater down to the desired TDS content. The terms “continuous deionization” and “continuous desalination”, which are used herein interchangeably, refer to the deionization process which is not interrupted by charging of the DFC, replenishment of the oxidant, reductant or both, and/or by deionized liquid removal. In some embodiments, the total weight or volume of the oxidant and/or reactant, which is present in the system, allows reduction of the TDS content of the feedwater to below about 3000 ppm without the need to add a new portion of said oxidant and/or said reductant to the catholyte and/or anolyte during the discharge step.

In some embodiments, the total weight or volume of the oxidant and/or reductant present in the system, is chosen to result in mass transport limiting current which is higher than the limiting current resulting from the ion transport in the first feedwater flow channel and/or at the first CEM or first AEM surfaces. It was shown by the inventors of the present invention that the limiting current of an exemplary zinc-bromine DFC was an order of magnitude lower than in a conventional zinc-bromine electrochemical cell with similar bromine concentration, suggesting that the limiting current was not due to the exhaustion of the oxidant at the cathode.

The feedwater, which can be deionized by the system and method of the present invention can be selected from seawater, brackish water, hard water, wastewater and organic streams needing remediation. The term “feedwater”, as used herein, is therefore meant to encompass aqueous solutions, organic liquids, and mixtures thereof.

The deionization process according to the principles of the present invention, provides removal of charged species from the feedwater. However, the present deionization process can also be applied to neutral species in the feedwater stream, by ionizing and/or radicalizing said species, thereby making them amenable to removal. Accordingly, in some embodiments, the method of deionization of a liquid comprises inputting energy into the DFC system to ionize and/or radicalize uncharged species in the feedwater. According to some embodiments, the step of inputting energy is performed during the discharging of the DFC. According to other embodiments, the step of inputting energy is performed before the discharging of the DFC. According to further embodiments, the step of inputting energy is performed by applying at least one of a high voltage, heat, sonication, or electromagnetic radiation to the DFC. Each possibility represents a separate embodiment of the invention.

According to certain embodiments, the step of inputting energy is performed by applying a high voltage to the DFC. The term “high voltage”, as used herein, refers in some embodiments, to a voltage, which is at least 2 times higher than the voltage required for the DFC charging. In further embodiments, the term “high voltage” refers to a voltage, which is at least 3 times higher, at least 4 times higher, at least 5 times higher or at least 10 times higher than the voltage required for the DFC charging. Each possibility represents a separate embodiment of the invention. According to some embodiments, the term “high voltage” refers to a voltage, which is above about 2 V. According to further embodiments, the term “high voltage” refers to a voltage, which is above about 3 V, about 4 V, about 5V, or about 6V. Each possibility represents a separate embodiment of the invention. According to some embodiments, the term “high voltage” refers to a voltage ranging from about 2 V to about 10 V. According to further embodiments, the term “high voltage” refers to a voltage ranging from about 4 V to about 8 V.

According to some embodiments, the feedwater is seawater. According to some embodiments, the TDS content of the feedwater prior to the electrochemical operation of the DFC is at least about 15 ppt (parts-per-thousand). According to further embodiments, the TDS content of the feedwater prior to the electrochemical operation of the DFC is at least about 20 ppt, at least about 25 ppt, at least about 30 ppt, at least about 35 ppt, at least about 40 ppt, at least about 50 ppt, at least about 60 ppt, at least about 70 ppt, at least about 80 ppt, or at least about 90 ppt.

According to some embodiments, the feedwater is brackish water. According to some embodiments, the TDS content of the feedwater prior to the electrochemical operation of the DFC is at least about 0.5 ppt. According to further embodiments, the TDS content of the feedwater prior to the electrochemical operation of the DFC is at least about 1 ppt, at least about 5 ppt, at least about 10 ppt, at least about 15 ppt, at least about 20 ppt, at least about 25 ppt, at least about 30 ppt, or at least about 35 ppt.

In some embodiments, the feedwater comprises alkali metal cations, such as, for example, sodium (Na⁺), potassium (K⁺), lithium (Li⁺); alkaline earth metal cations, including calcium (Ca²⁺), magnesium (Mg²⁺), or strontium (Sr²⁺); heavy metal ions, including mercury (Hg²⁺), iron (Fe²⁺), lead (Pb²⁺), cadmium (Cd²⁺), arsenic (As³⁺), copper (Cu²⁺), nickel (Ni²⁺), or chromium (Cr⁺) ions; ammonium (NH₄⁺) ions; halide anions, such as chloride, fluoride, bromide, and iodide; additional anions, including sulfate (SO₄²⁻); bicarbonate (HCO₃⁻); borate (BO₃³⁻); silicate (SiO₃²⁻); phosphate (PO₄³⁻), or nitrate (NO₃⁻) ions; or any combination thereof. In some exemplary embodiments, the feedwater comprises dissolved NaCl salt at a concentration of about 30 g/L.

According to some embodiments, the reductant and the oxidant suitable for use in the system of the present invention are carefully chosen to ensure that they and their redox reaction products are electrostatically blocked from entering the first feedwater flow channel through the first CEM and the first AEM. In order to allow the use of different types of DFC chemistries in the deionization system and method of the present invention, more than one CEM and AEM can be employed in the cell, thereby forming additional feedwater flow channels.

Thus, in some embodiments, the DFC comprises (n) CEMs and (n) AEMs, which form (2n−1) feedwater flow channels, wherein n≥1. In certain embodiments, n=1. For example, the DFC can include one CEM and one AEM, wherein the CEM is disposed between the cathode and the AEM; and the AEM is disposed between the anode and the CEM. The catholyte flow channel is formed between the cathode and the CEM and the anolyte flow channel is formed between the anode and the AEM. The first feedwater flow channel is formed between the AEM and the CEM. Preferably, the first feedwater flow channel is configured to deionize feedwater. In certain such embodiments, the oxidant is neutral and/or the product of its reduction reaction is negatively charged. Alternatively, the oxidant can be negatively charged, while the product of its reduction reaction is also negatively charged. In further embodiments, the reductant is neutral and/or a product of its oxidation reaction is positively charged. Alternatively, the reductant can be positively charged, while the product of its oxidation reaction is also positively charged. One non-limiting example of a suitable DFC in which the oxidant and the reductant are neutral is a zinc-bromine fuel cell.

In some embodiments, the DFC comprises (n+1) CEMs and (n) AEMs, which form (2n) feedwater flow channels, wherein n≥1. In certain embodiments, n=1. For example, the DFC can include a first CEM, a second CEM and a first AEM, wherein the first CEM is disposed between the cathode and the first AEM; the second CEM is disposed between the anode and the first AEM; and the first AEM is disposed between the first CEM and the second CEM. The catholyte flow channel is formed between the cathode and the first CEM and the anolyte flow channel is formed between the anode and the second CEM. The first feedwater flow channel is formed between the first AEM and the first CEM. A second feedwater flow channel is formed between the first AEM and the second CEM. The DFC according to certain such embodiments therefore comprises three membranes and two feedwater flow channels. Preferably, the first feedwater flow channel is configured to deionize feedwater and the second feedwater flow channel is configured to concentrate feedwater. In certain such embodiments, the oxidant is neutral and/or the product of its reduction reaction is negatively charged. Alternatively, the oxidant can be negatively charged, while the product of its reduction reaction is also negatively charged. In further embodiments, the reductant is negatively charged and/or a product of its oxidation reaction is negatively charged. Alternatively, the reductant can be negatively charged, while the product of its oxidation reaction is neutral. Non-limiting examples of suitable DFCs comprising such neutral or negatively charged oxidant and negatively charged reductant include sulfur-oxygen fuel cells and hydrogen-oxygen fuel cells. In certain such embodiments, the hydrogen-oxide fuel cell is an alkaline fuel cell or fuel cell comprising an alkaline catholyte.

In some embodiments, the DFC comprises (n) CEMs and (n+1) AEMs, which form (2n) feedwater flow channels, wherein n≥1. In certain embodiments, n=1. For example, the DFC can include a first CEM, a first AEM, and a second AEM, wherein the first AEM is disposed between the anode and the first CEM; the second AEM is disposed between the cathode and the first CEM; and the first CEM is disposed between the first AEM and the second AEM. The catholyte flow channel is formed between the cathode and the second AEM and the anolyte flow channel is formed between the anode and the first AEM. The first feedwater flow channel is formed between the first AEM and the first CEM. A second feedwater flow channel is formed between the first CEM and the second AEM. The DFC according to certain such embodiments therefore comprises three membranes and two feedwater flow channels. Preferably, the first feedwater flow channel is configured to deionize the feedwater and the second feedwater flow channel is configured to concentrate feedwater. In certain such embodiments, the oxidant is positively charged and/or the product of its reduction reaction is positively charged. Alternatively, the oxidant can be positively charged, while the product of its reduction reaction is neutral. In further embodiments, the reductant is neutral and/or a product of its oxidation reaction is positively charged. Alternatively, the reductant can be positively charged, while the product of its oxidation reaction is also positively charged. Non-limiting examples of suitable DFCs comprising such positively charged oxidant and positively charged or neutral reductant include an all-iron fuel cell and an all-vanadium fuel cell.

In some embodiments, the DFC comprises (n) CEMs and (n) AEMs, which form (2n) feedwater flow channels, wherein n≥1. In certain embodiments, n=2. For example, the DFC can include a first CEM, a second CEM, a first AEM, and a second AEM, wherein the second CEM is disposed between the anode and the first AEM; the second AEM is disposed between the cathode and the first CEM; the first CEM is disposed between the first AEM and the second AEM; and the first AEM is disposed between the first CEM and the second CEM. The catholyte flow channel is formed between the cathode and the second AEM and the anolyte flow channel is formed between the anode and the second CEM. The first feedwater flow channel is formed between the first AEM and the first CEM. A second feedwater flow channel is formed between the first AEM and the second CEM. A third feedwater flow channel is formed between the second AEM and the first CEM. The DFC according to certain such embodiments therefore comprises four membranes and three feedwater flow channels. Preferably, the first feedwater flow channel is configured to deionize the feedwater and the second and third feedwater flow channels are configured to concentrate feedwater. In certain such embodiments, the oxidant is positively charged and/or the product of its reduction reaction is positively charged. Alternatively, the oxidant can be positively charged, while the product of its reduction reaction is neutral. In further embodiments, the reductant is negatively charged and/or a product of its oxidation reaction is negatively charged. Alternatively, the reductant can be negatively charged, while the product of its oxidation reaction is neutral. One non-limiting example of a suitable DFC comprising such positively charged oxidant and negatively charged reductant is an iron-sulfur fuel cell.

When the DFC includes more than one feedwater flow channel, the deionization system can further comprise a brine tank, which stores concentrated feedwater, also termed herein “brine”. In some embodiments, the brine tank is being operatively connected to the second feedwater flow channel, the third feedwater flow channel or both.

According to some aspects and embodiments, the reductant and the oxidant suitable for use in the system of the present invention are carefully chosen to ensure that if they diffuse into the first feedwater flow channel through the first CEM and the first AEM, they recombine in the first feedwater flow channel to obtain a neutral non-ionic compound. In certain such embodiments, even if the oxidant is positively charged and the reductant is negatively charged, a single CEM and a single AEM can be employed in the cell and the DFC therefore includes a single feedwater flow channel.

According to some aspects and embodiments, the concentrations of the reductant and the oxidant are controlled to minimize their diffusion to the first feedwater flow channel through the first CEM and the first AEM. In certain such embodiments, even if the oxidant is positively charged and the reductant is negatively charged, a single CEM and a single AEM can be employed in the cell and the DFC therefore includes a single feedwater flow channel.

As mentioned hereinabove, the suitable types of fuel cells, which can be employed as a DFC according to the principles of the present invention, can be based on various chemicals, including, inter alia, halogen-containing compounds, such as bromine or iodine; metal and metal ions, including zinc, iron and vanadium; sulfur-containing compounds; and gases, such as oxygen and hydrogen. Non-limiting examples of such fuel cells include zinc-bromine fuel cell, bromine-polysulfide fuel cell; hydrogen-bromine fuel cell; sulfur-oxygen fuel cell, such as, for example, air-breathing aqueous sulfur fuel cell; zinc-polyiodide fuel cell; iron-sulfur fuel cell; all-iron fuel cell; hydrogen-oxygen fuel cell, such as, for example, proton exchange membrane fuel cell (PEMFC), alkaline fuel cell (AFC), or dual electrolyte hydrogen-oxygen fuel cell; acid-base fuel cell; polysulfide-polyiodide fuel cell; all-vanadium fuel cell; and iodine-vanadium fuel cell. The DFC can also be organic-based, such as, for example, a hydroquinone fuel cell.

The DFC can be based on solid, liquid or gaseous redox active species and their reduction and oxidation products. In some embodiments, the DFC comprises liquid redox active species and/or their reduction and oxidation products. In some embodiments, the DFC comprises a combination of liquid and solid redox active species. In further embodiments, the DFC comprises a combination of a liquid oxidant and solid reductant. The term “liquid redox active species”, as used herein, refers in some embodiments to a solution of the oxidant and/or reductant in an aqueous or organic solvent. In additional embodiments, the term “liquid redox active species”, as used herein, refers to an oxidant and/or reductant being in a liquid state of matter. Non-limiting examples of suitable redox active species for a half-cell reaction of a DFC, in which the reactant is in form of a solution, include bromine/bromide (Br₂/Br⁻) or tri-bromine/bromide (Br₃⁻/Br⁻); polysulfide (S₂²⁻/S₄²⁻); sulfur/sulfide (S/S²); iodine/iodide (I₂/I⁻) or tri-iodide/iodide (I₃⁻/I⁻); polyiodide; iron (Fe²⁺/Fe³⁺); vanadium (V⁴⁺/V⁵⁺); and ferro-/ferri-cyanide ([Fe(CN)₆]⁴⁻/[Fe(CN)₆]³⁻). One non-limiting example of suitable reactants for a half-cell reaction of a DFC, in which the redox active species is in a solid form is zinc/zinc(II) (Zn/Zn²⁺). In some embodiments, the DFC comprises gaseous reactants, such as, for example, hydrogen, oxygen or air.

In some embodiments, the reductant for use in the deionization method and system is selected from the group consisting of zinc, sulfur, hydrogen, hydroxyl ion, vanadium, and combinations thereof. The term “sulfur”, as used herein, is mean to encompass elemental sulfur, sulfide and polysulfide. The term “sulfide”, as used herein refers to an inorganic anion of sulfur with the chemical formula S²⁻ or a compound containing one or more S²⁻. The term “polysulfide”, as used herein, refers to a chemical compound containing a chain of at least two sulfur atoms. Polysulfides can include anions and organic polysulfides, wherein the anions have the general formula Sₙ²⁻ and the organic polysulfides have the formula RSₙR, where R can be alkyl or aryl, either substituted or unsubstituted. In some embodiments, vanadium includes V(IV) ions.

In some embodiments, the oxidant for use in the deionization method and system is selected from the group consisting of bromide, iodide, oxygen, air, hydroxyl ion, iron, and combinations thereof. In some embodiments, iron includes ferric (Fe(III)) ions.

In some embodiments, the catholyte comprises a solution of the oxidant in a suitable electrolyte or solvent. The catholyte can further include a product of the oxidant reduction reaction. In certain embodiments, said product of the reduction reaction is also dissolved in the electrolyte or solvent. In some embodiments, the anolyte comprises a solution of the reductant in a suitable electrolyte or solvent. The anolyte can further include a product of the reductant oxidation reaction. In certain embodiments, said product of the oxidation reaction is also dissolved in the electrolyte or solvent. The electrolyte or solvent can be aqueous or organic-based. Non-limiting examples of aqueous-based solvents include water; acidic solution, such as, hydrochloric acid, sulfuric acid, hydrobromic acid, or trifluoromethanesulfonic acid (TFMS); and alkaline solution, such as, sodium hydroxide, potassium hydroxide, lithium hydroxide, or ammonium hydroxide. Non-limiting examples of suitable organic solvents include propylene carbonate and ethylene glycol. The anolyte and/or catholyte can further include an additive selected from a complexation agent, such as, but not limited to, quaternary amines, Methyl Ethyl Pyrrolidinium Bromide (MEP), Methyl Ethyl Morpholinium (MEM); and ionic strength adjuster, including various water-soluble salts.

According to some embodiments, the chemical composition of the catholyte is different from the composition of the anolyte. The term “different chemical composition”, as used herein, refers to the catholyte, which includes at least one constituent, which is not present in the anolyte, and vice versa. In further embodiments, the catholyte comprises cations which are the same as the cations contained in the feedwater. In still further embodiments, the anolyte comprises anions which are the same as the anions contained in the feedwater.

Each one of the anolyte and the catholyte can be acidic, neutral or alkaline. In certain embodiments, the anolyte is alkaline. In additional embodiments, the catholyte is acidic. The hydroxyl and/or hydronium ions can be used as reactants in the oxidation and/or reduction reaction, as counterions or to adjust pH to desired levels, in accordance with the chosen type of the DFC, as known in the art.

In some embodiments, the anolyte and the catholyte are aqueous based solutions. Said aqueous solutions can contain counterions, which balance the overall charge of the anolyte and/or the catholyte induced by the charged reductant and/or the oxidant. In some embodiments, the catholyte comprises hydronium ion, alkali metal cations and/or alkaline earth metal cations. In some embodiments, said cations are the same as the cations contained in the feedwater. Non-limiting examples of such cations include sodium (Na⁺), potassium (K⁺), lithium (Li⁺), and other cations, as detailed herein above. In some exemplary embodiments, the catholyte comprises sodium cations. In some embodiments, the catholyte further comprises the oxidant or the oxidant reduction reaction product, such as, but not limited to, bromine, bromide, tribromide, iodide, iodine, triiodide, hydronium, hydroxide, and ferrous and ferric ions. In some exemplary embodiments, the catholyte comprises bromine and bromide ions. Bromine can be present in the catholyte in a form of a tribromide ion. In additional exemplary embodiments, the catholyte comprises hydronium ions.

In some embodiments, the anions contained in the anolyte are the same as the anions contained in the feedwater. In some embodiments, the anolyte comprises halide anions, such as chloride, fluoride, bromide, and iodide; sulfate (SO₄²⁻); bicarbonate (HCO₃⁻); borate (BO₃³⁻); silicate (SiO₃²⁻); and other anions, as detailed hereinabove. In some exemplary embodiments, the anolyte comprises chloride ions. In some embodiments, the anolyte further comprises the reductant or the reductant oxidation reaction product, such as, but not limited to, zinc ions, ferrocyanide, ferricyanide, hydronium, hydroxide, vanadium ions, and polysulfide ions. In some exemplary embodiments, the anolyte comprises zinc ions. In additional exemplary embodiments, the anolyte comprises hydroxyl ions.

The cathode and the anode material can be selected based on the type of the DFC used and the reactions taking place at the anode and at the cathode. The anode and the cathode should be sufficiently electrically conductive to allow current passage therethrough without significant energy losses. Further, the anode and the cathode should be chemically inert in the presence of the anolyte and catholyte, respectively, unless they are deliberately chosen to participate in the oxidation and/or reduction reactions, respectively.

In some embodiments, the anode, the cathode, or both include a material selected from carbon, metal, metal carbide, metal nitride, metal oxide, polymer, and any combination thereof. Carbon-based materials can be selected from graphitic carbon, activated carbon, carbon black, carbon beads, carbon fibers, carbon microfibers, carbon cloth, carbon paper, fullerenic carbons, carbon nanotubes (CNTs), including multiwall carbon nanotubes (MWCNTs) and single wall carbon nanotubes (SWCNTs); graphene sheets or aggregates of graphene sheets, and materials comprising fullerenic fragments, and any combination thereof. Non-limiting examples of metals suitable for use in the anode and/or cathode include Zn, Fe, Ni, Co, Cr, Al, Pt, Pd, Ru, Au, Ir, Cu, Ce, Cd, Ti and alloys, and combinations thereof. Suitable metal oxides include, but are not limited to, LiCoO₂, LiFeO₂, LiMnO₂, LiMn₂O₄, Li₂MoO₄, LiNiO₂, IrO₂, and combinations thereof.

In some embodiments, the anode comprises the reductant. In further embodiments, the anode constitutes the reductant. In some embodiments, the cathode comprises the oxidant. In further embodiments, the cathode constitutes the oxidant. In certain such embodiments, the anode and/or the cathode should be present in the DFC in an amount sufficient to provide a single-step deionization, as explained hereinabove. One non-limiting example of an anode comprising the reductant includes Zn.

In some embodiments, the anode comprises a catalyst for the oxidation reaction taking place at the anode. Non-limiting examples of said catalyst suitable for the oxidation reaction include noble metals, such as, for example, Pt, Ru, Ir, Pd, and other metals, such as Ni, Co or Fe. In some embodiments, the cathode comprises a catalyst for the reduction reaction taking place at the cathode. Said catalyst suitable for the reduction reaction can be selected from the metal catalysts of the oxidation reduction. The catalyst can comprise a pure metal, e.g., being in a form of a metal powder or, alternatively, can comprise a metal, which is supported on a high surface area carbon powder. The anode and/or the cathode suitable for use in the DFC can be in a form of a planar solid electrode. The planar solid electrode can be of any type suitable for use in a fuel cell, including, but not limited to, plate, sheet, foil, film, cloth, paper, mesh or felt. Thickness of the planar solid electrode can range from about 0.01 mm to about 10 mm.

In some exemplary embodiments the cathode comprises a graphite plate. In further exemplary embodiments, the anode comprises a zinc sheet. In certain embodiments, the anode thickness ranges from about 0.1 to about 1 mm.

In some exemplary embodiments the cathode and/or the anode comprise a carbon cloth. In further exemplary embodiments, the cathode and/or the anode comprise a catalyst. In certain embodiments, said catalyst is Pt. Loading of the catalyst upon the carbon cloth can range from about 0.01 to about 10 mg/cm².

In some embodiments, the anode and/or the cathode is porous. In some embodiments, the anode and/or cathode have high surface area. In some embodiments, the anode and/or the cathode has a surface area of above about 500 m²/g. In further embodiments, the anode and/or the cathode has a surface area of above about 1000 m²/g. In some embodiments, the surface area of the anode and/or of the cathode ranges between about 500 and about 3000 m²/g.

In further embodiments, the anode and/or the cathode comprises a backing layer, such as, for example, a metal or carbon mesh or a carbon-based gas diffusion layer.

The AEM and the CEM can be selected based on the composition of the feedwater, the anolyte and/or catholyte solvent or electrolyte and the reactions taking place at the anode and at the cathode.

AEMs can be described as polymer electrolytes that conduct anions, such as, for example, Cl⁻, as they contain positively charged (cationic) groups, typically bound covalently to a polymer backbone. These cationic functional groups can be bound either via extended side chains (alkyl or aromatic types of varying lengths) or directly onto the backbone (often via CH₂ bridges); or can be an integral part of the backbone. Non-limiting examples of suitable AEM types include non-alkaline anion exchange membrane, alkaline anion exchange membrane (AAEM), hydroxide-exchange membrane (HEM), anion-exchange ionomer membrane (AEI), and combinations thereof. The polymer backbones suitable for use in the AEM include, inter alia, poly(arylene ethers) of various chemistries, such as polysulfones (including cardo, phthalazinone, fluorenyl, and organic-inorganic hybrid types), poly(ether ketones), poly(ether imides) poly(ether oxadiazoles), and poly(phenylene oxides) (PPO); polyphenylenes, perfluorinated types, polybenzimidazole (PBI) types including where the cationic groups are an intrinsic part of the polymer backbones, poly(epichlorohydrins) (PECH), unsaturated polypropylene and polyethylene types, including those formed using ring opening metathesis polymerisation (ROMP), those based on polystyrene, poly(styrene/divinyl benzene) (PS/DVB), and poly(vinylbenzyl chloride), polyphosphazenes, radiation-grafted types, those synthesized using plasma techniques, pore-filled types, electrospun fiber types, PTFE-reinforced types, and those based on poly(vinyl alcohol) (PVA). Non-limiting examples of suitable cationic groups include amines, quaternary ammoniums (QA) such as, for example, benzyltrialkylammoniums; heterocyclic systems including imidazolium, benzimidazoliums, PBI systems where the positive charges are on the backbone (with or without positive charges on the side-chains), and pyridinium types; guanidinium systems (e.g., pentamethylguanidinium groups); P-based systems types including stabilized phosphoniums (e.g. tris(2,4,6-trimethoxyphenyl)phosphonium and P—N systems such as phosphatranium and tetrakis(dialkylamino)phosphonium systems; sulfonium types; and metal-based systems where an attraction is the ability to have multiple positive charges per cationic group.

CEMs can be described as polymer electrolytes that conduct cations, such as, for example, Na⁺, as they contain negatively charged (anionic) groups, typically bound covalently to a polymer backbone. Non-limiting examples of suitable CEM types include non-acidic cation exchange membrane, proton-exchange membrane (PEM), cation-exchange ionomer membrane, and combinations thereof. The polymer backbones suitable for use in the CEM include, inter alia, sulfonate containing fluoropolymer, such as, for example, NAFION®; sulfonated poly(ether ether ketone); polysulfone; poly(styrene/divinyl benzene (PS/DVB); polyethylene; polypropylene; ethylene-propylene copolymer; polyimide; and polyvinyldifluoride. Non-limiting examples of suitable anionic groups include sulfite, carboxy, and phosphite groups. Additionally, lithium super ionic conductor (LISICON) membranes can be used

The CEM and/or AEM can further be in a form of anion or cation-selective porous separators e.g., ion conductive ceramic, zeolite, or glass separators. Said anion or cation-selective porous separators can be particularly useful, when using three- or four-membrane DFC design.

In some embodiments, the AEM and the CEM comprise a poly(styrene/divinyl benzene (PS/DVB) backbone with suitable cationic and anionic groups.

In some embodiments, the first CEM and the second CEM are of the same type. In other embodiments, the first CEM and the second CEM are different.

In some embodiments, the first AEM and the second AEM are of the same type. In other embodiments, the first AEM and the second AEM are different.

The DFC can further comprise at least one gasket or a spacer between the cathode and the CEM and/or between the AEM and the anode. In some embodiments, the DFC further comprises at least one gasket or a spacer between the CEM and the AEM. Said gasket or separator can further define the catholyte flow channel, the anolyte flow channel and/or the feedwater flow channel. In particular, the gasket or a spacer can dictate the thickness of the flow channels. In some embodiments, the feedwater flow channel is longer than the anolyte and the catholyte flow channels. The gasket can be made of any suitable material, including, but not limited to, polymer, rubber or elastomer. The spacer can include, inter alia, a planar slit, mesh or transport channel. In some embodiments, the spacer is made of a porous material.

The DFC can further include a first current collector disposed adjacent to the cathode and/or a second current collector disposed adjacent to the anode. Selection of current collector materials is well-known to those skilled in the art. In some exemplary embodiments, titanium is used as the first current collector. In further embodiments, the reductant is in a form of a solid electrode, which is further used as a second current collector.

The DFC can further include endplates enclosing the cathode and the anode and/or their respective current collectors. Various suitable designs of the endplates are known in the art. The endplates can be made of a polymer, such as, but not limited to, acrylic and polyvinylidene fluoride (PVDF).

The DFC can further include bipolar plates being disposed adjacent to the anode or the cathode.

Typically, the anode, the cathode, the CEM and the AEM are disposed in parallel to each other. In further embodiments, the DFC has a rectangular shape.

The deionization system can include a plurality of DFC cells. In certain such embodiments, the DFCs are configured in a stack configuration, having multiple cells connected in series or in parallel. In certain embodiments, the anolyte flow channels of the plurality of DFCs are in fluid flow connection with a single anolyte tank, the catholyte flow channels of the plurality of DFCs are in fluid flow connection with a single catholyte tank and/or the first feedwater flow channels of the plurality of DFCs are in fluid flow connection with a single feedwater tank and/or deionized feedwater tank. The second and third feedwater flow channels of the plurality of DFCs can be in fluid flow connection with a single brine tank.

In some exemplary embodiments, the DFC is a zinc-bromide fuel cell. The reversible half-cell and overall reactions are presented in Equations 1-3 below.

Zn₍ₛ₎+2Cl⁻→2e⁻+ZnCl_{2(aq)}, Equation (1), anode half-cell reaction.

Br₂₍ₗ₎+2Na⁺_{(aq)}+2e⁻→2NaBr_{(aq)}, Equation (2), cathode half-cell reaction.

Zn₍ₛ₎+Br₂₍ₗ₎+2Na⁺_{(aq)}+2Cl⁻→ZnCl_{2(aq)}+2NaBr_{(aq)}, Equation (3), overall reaction.

In certain such embodiments, the oxidant is bromine, which can be present in the catholyte in a form of tribromide ions. The oxidant reduction reaction product is bromide, which is also present in the catholyte. The catholyte can be in a form of an aqueous solution. Concentration of tribromide in the catholyte can range from about 0.5 M to about 3 M. In certain embodiments, the concentration of tribromide is about 1 M.

The catholyte can also include a complexation agent (e.g., quaternary ammonium complex) configured to capture bromine and keep it within the catholyte solution. In further embodiments, the catholyte includes alkali metal or alkaline earth metal cations. In certain embodiments, the catholyte comprises sodium cations.

The cathode can be selected from graphite or carbon.

In the zinc-bromine DFC the reductant is zinc, which is present in the system in a form of a solid electrode (i.e., anode). The reductant oxidation reaction product is Zn²⁺, which is also present in the anolyte. Concentration of zinc cations in the anolyte can range from about 0.5 M to about 3M. In certain embodiments, the concentration of zinc cations is about 2 M. In further exemplary embodiments, the anolyte is an aqueous solution comprising zinc cations and halide anions. In certain embodiments, the anolyte comprises chloride anions.

According to an aspect and some embodiments of the invention, there is provided a deionization fuel cell system, comprising: (a) a deionization fuel cell (DFC) comprising: a cathode; an anode; a catholyte flow channel, an anolyte flow channel, a cation exchange membrane (CEM); an anion exchange membrane (AEM), and a feedwater flow channel, wherein: the catholyte flow channel is disposed between the cathode and the CEM, the anolyte flow channel is disposed between the anode and the AEM, and the feedwater flow channel is disposed between the CEM and the AEM, and (b) a plurality of storage tanks comprising: a feedwater tank being operatively connected to the feedwater flow channel, a catholyte tank being operatively connected to the catholyte flow channel, and an anolyte tank being operatively connected to the anolyte flow channel, wherein the feedwater tank comprises feedwater to be deionized, and the catholyte tank comprises a catholyte comprising an oxidant comprising hydronium ions and the anolyte tank comprises an anolyte comprising a reductant comprising hydroxyl ions.

The DFC can be selected from a hydrogen-oxygen DFC or an acid-base DFC, as detailed hereinbelow.

According to some embodiments, the DFC is a hydrogen-oxygen DFC. In certain embodiments, the hydrogen-oxygen DFC is a dual electrolyte hydrogen-oxygen DFC. In further embodiments, the oxidant further comprises oxygen gas being supplied to the cathode. In still further embodiments, the reductant further comprises hydrogen gas being supplied to the anode.

According to some embodiments, the DFC is an acid-base DFC. In further embodiments, the oxidant further comprises oxygen gas being supplied to the cathode.

According to some embodiments, the catholyte is an aqueous solution comprising HCl and an alkali metal or alkaline earth metal salt. According to some embodiments, the anolyte is an aqueous solution comprising NaOH and an alkali metal or alkaline earth metal salt. The alkali metal or alkaline earth metal salt can include, for example, sodium, potassium, lithium, calcium, magnesium, or strontium cations and/or chloride, fluoride, bromide, iodide, sulfate, bicarbonate, phosphate, or nitrate anions. According to certain embodiments, the catholyte comprises HCl and NaCl. According to certain embodiments, the anolyte comprises NaOH and NaCl.

Concentration of the protons and hydroxyl ions in the catholyte and anolyte can be carefully chosen to maximize the deionization efficiency. High concentrations of H⁺ and OH⁻ provide higher voltage difference between anode and cathode (i.e., OCV), thereby increasing the energy of the discharge and enhancing the driving force for the ion removal. On the other hand, high concentrations of said ions may increase their diffusion into the feedwater flow channel, such that the ionic current through the CEM and AEM would include mainly H⁺ and OH⁻, instead of the the feedwater ions diffusion, resulting in a less efficient deionization.

Concentration of HCl in the anolyte of the DFC can range from about 0.1 mM to about 1 M. According to further embodiments, the concentration of HCl ranges from about 1 mM to about 0.5 M. In yet further embodiments, the concentration of HCl ranges from about 10 mM to about 0.5 M. In certain embodiments, the concentration of HCl is about 0.1 M. In additional embodiments, the concentration of HCl ranges from about 0.1 mM to about 0.1 M. In certain embodiments, the concentration of HCl is about 1 mM.

Concentration of NaOH in the anolyte of the DFC can range from about 0.1 mM to about 1 M. According to further embodiments, the concentration of NaOH ranges from about 1 mM to about 0.5 M. In yet further embodiments, the concentration of NaOH ranges from about 10 mM to about 0.5 M. In certain embodiments, the concentration of NaOH is about 0.1 M. In additional embodiments, the concentration of NaOH ranges from about 0.1 mM to about 0.1 M. In certain embodiments, the concentration of NaOH is about 1 mM.

According to certain embodiments, the concentration of HCl in the catholyte ranges from about 0.1 mM to about 1 M. According to further embodiments, the concentration of NaOH in the anolyte ranges from about 0.1 mM to about 1 M. Preferably, the concentration of the alkali metal or alkaline earth metal salt is at least about 5 times higher than the concentration of each of the HCl and NaOH. In certain embodiments, the concentration of the alkali metal or alkaline earth metal salt is at least about 10 times higher than the concentration of each of the HCl and NaOH.

The anode and/or the cathode of the hydrogen-oxygen DFC and/or the acid-base DFC can be chosen as known in the art, for example in the field of fuel cells. In some embodiments, the cathode of said DFC comprises a gas diffusion layer. In further embodiments, the anode of said DFC comprises a gas diffusion layer. Preferably, the cathode, the anode or both further comprise a catalytic layer comprising a noble metal catalyst, selected from, but not limited to, Pt, Ru, Ir, or Pd.

In some exemplary embodiments, the DFC is a hydrogen-oxygen fuel cell. The reversible half-cell and overall reactions are presented in Equations 4-6 below.

H₂_{_{(g)}}+2OH⁻_{(aq)}→2e⁺+2H₂O₍ₗ₎, Equation (4), anode half-cell reaction

O_{2(g)}+4H⁺_{(aq)}+2e⁻→2H₂O₍ₗ₎, Equation (5), cathode half-cell reaction

2H₂_{_{(g)}}+O_{2(g)}→2H₂O₍ₗ₎, Equation (6), overall reaction

Without wishing to being bound by theory or mechanism of action, it is contemplated that since the catholyte and the anolyte are separated by a CEM, AEM, and a feedwater flow channel, it is possible to use an anolyte and a catholyte having different acidity levels. In certain such embodiments, the hydrogen-oxygen DFC is a dual electrolyte hydrogen-oxygen DFC, which employs two different types of electrolytes (i.e., acidic catholyte and alkaline anolyte), thereby increasing the OCV and the energy, which can be obtained from the DFC.

The oxidant of the hydrogen-oxygen DFC comprises oxygen gas, which can be supplied to the reaction site in the interface between the catholyte and the cathode through the gas diffusion layer of the cathode. Cathode half-cell reaction also involves hydronium ion (or proton). In certain such embodiments, the oxidant further comprises hydronium ion. The product of the oxidant reduction reaction is water, which is also present in the catholyte. The catholyte can be in a form of an acidic aqueous solution. The catholyte can further include counter ions, such as, for example, halide anions. In some embodiments, the catholyte comprises HCl. Concentration of HCl in the catholyte can range from about 0.1 mM to about 1 M. In some embodiments, the concentration of HCl in the catholyte ranges from about 0.1 mM to about 0.1 M. In certain embodiments, the concentration of HCl is about 1 mM.

The catholyte can also include additional cations, to increase ionic conductivity and/or ionic strength of the catholyte, e.g., alkali metal or alkaline earth metal cations. In certain embodiments, the catholyte comprises sodium cations. In further embodiments, the catholyte comprises HCl and NaCl. In certain embodiments, the concentration of the alkali metal or alkaline earth metal cations is at least about 5 times higher than the concentration of HCl. In further embodiments, the concentration of NaCl ranges from about 0.5 mM to about 2.5 M.

The cathode can comprise carbon, e.g., a carbon cloth, which serves as a gas diffusion layer. The cathode can further contain a catalytic layer disposed on the gas diffusion layer. In some exemplary embodiments, the catalytic layer comprises Pt.

In the hydrogen-oxygen DFC the reductant is hydrogen, which is supplied to the reaction site in the interface between the anolyte and the anode through the gas diffusion layer of the anode. Anode half-cell reaction also involves hydroxyl ion. In certain such embodiments, the reductant further comprises hydroxyl ion. The reductant oxidation reaction product is also water, which is present in the anolyte. The anolyte can be in a form of an alkaline aqueous solution. The anolyte can further include counter ions, such as, for example, alkali metal or alkaline earth metal cations. In some embodiments, the anolyte comprises NaOH. Concentration of NaOH in the anolyte can range from about 0.1 mM to about 1 M. In some embodiments, the concentration of NaOH in the anolyte ranges from about 0.1 mM to about 0.5 M. In certain embodiments, the concentration of NaOH is about 1 mM.

The anolyte can also include additional anions, to increase ionic conductivity and/or ionic strength of the anolyte, e.g., halide anions. In certain embodiments, the anolyte comprises chloride anions. In further embodiments, the anolyte comprises NaOH and NaCl. In certain embodiments, the concentration of the halide ions is at least about 5 times higher than the concentration of NaOH. In further embodiments, the concentration of NaCl ranges from about 0.5 mM to about 2.5 M.

The anode can comprise carbon, e.g., a carbon cloth, which serves as a gas diffusion layer. The anode can further contain a catalytic layer disposed on the gas diffusion layer. In some exemplary embodiments, the catalytic layer comprises Pt supported on carbon powder.

In some exemplary embodiments, the DFC is an acid-base fuel cell. The reversible half-cell and overall reactions are presented in Equations 7-9 below.

4OH⁻_{(aq)}→4e⁻+O_{2(g)}+2H₂O₍ₗ₎, Equation (7), anode half-cell reaction

O_{2(g)}+4H⁺_{(aq)}+4e⁻→2H₂O₍ₗ₎, Equation (8), cathode half-cell reaction

4OH⁻_{(aq)}+4H⁺_{(aq)}→4H₂O₍ₗ₎, Equation (9), overall reaction

In the acid-base DFC the oxidant comprises oxygen gas, which can be supplied to the reaction site in the interface between the catholyte and the cathode through the gas diffusion layer of the cathode. Cathode half-cell reaction also involves hydronium ion (or proton). In certain such embodiments, the oxidant further comprises hydronium ions. The oxidant reduction reaction is water, which is also present in the catholyte. The catholyte can be in a form of an acidic aqueous solution. The catholyte can further include counter ions, such as, for example, halide anions. In some embodiments, the catholyte comprises HCl. Concentration of HCl in the catholyte can range from about 0.1 mM to about 1 M. According to some embodiments, the concentration of HCl ranges from about 10 mM to about 0.5 M. In certain embodiments, the concentration of HCl is about 0.1 M.

The catholyte can also include additional cations, to increase ionic conductivity and/or ionic strength of the catholyte, e.g., alkali metal or alkaline earth metal cations. In certain embodiments, the catholyte comprises sodium cations. In further embodiments, the catholyte comprises HCl and NaCl. In certain embodiments, the concentration of the alkali metal or alkaline earth metal cations is at least about 5 times higher than the concentration of HCl. In further embodiments, the concentration of NaCl ranges from about 0.5 mM to about 2.5 M.

The cathode can comprise carbon, e.g., a carbon cloth, which serves as a gas diffusion layer. The cathode can further contain a catalytic layer disposed on the gas diffusion layer. In some exemplary embodiments, the catalytic layer comprises Pt.

In the acid-base DFC the reductant is hydroxide ion, which is present in the anolyte. The anolyte can, therefore, be in a form of an alkaline aqueous solution. The anolyte can further include counter ions, such as, for example, alkali metal or alkaline earth metal cations. The reductant oxidation reaction products include water, which is present in the anolyte, and oxygen gas, which can be resupplied to the cathode or which can be freely released through the anode to the cell ambiance. In some embodiments, the anolyte comprises NaOH. Concentration of NaOH in the anolyte can range from about 0.1 mM to about 1 M. According to some embodiments, the concentration of NaOH ranges from about 10 mM to about 0.5 M. In certain embodiments, the concentration of NaOH is about 0.1 M.

The anolyte can also include additional anions, to increase ionic conductivity and/or ion strength of the anolyte, e.g., halide anions. In certain embodiments, the anolyte comprises chloride anions. In further embodiments, the anolyte comprises NaOH and NaCl. In further embodiments, the concentration of NaCl ranges from about 0.5 mM to about 2.5 M.

The anode can comprise carbon, e.g., a carbon cloth, which serves as a gas diffusion layer. The anode can further contain a catalytic layer disposed on the gas diffusion layer. In some exemplary embodiments, the catalytic layer comprises Pt.

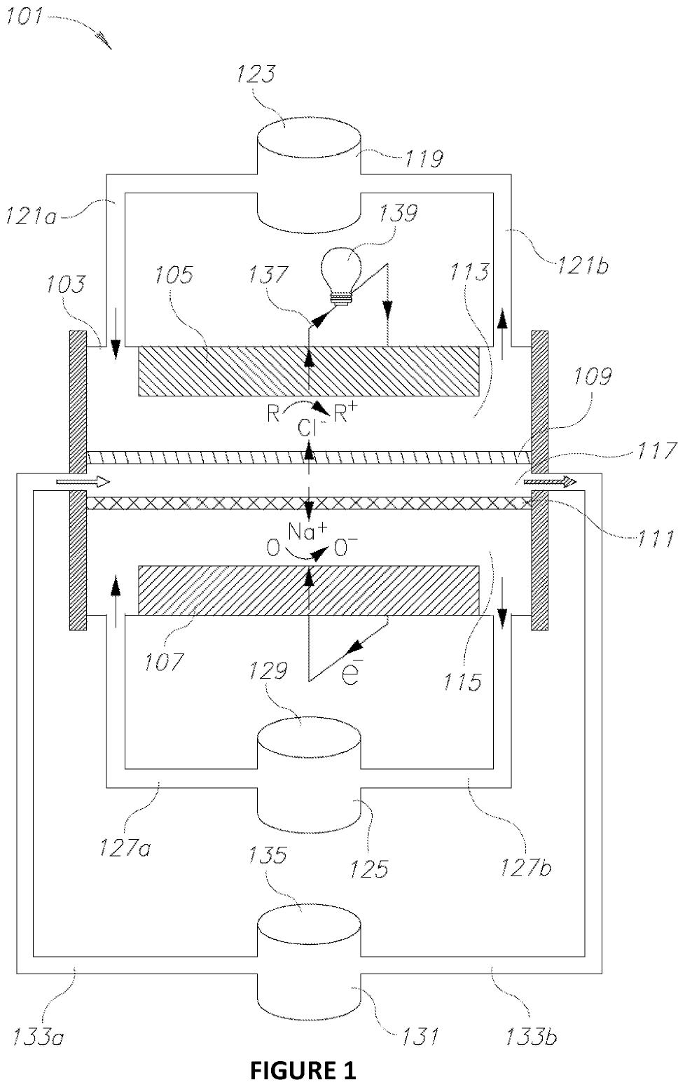

Reference is now made to FIG. 1, which schematically represents deionization fuel cell system 101, in accordance with some embodiments of the invention. Deionization fuel cell system 101 includes deionization fuel cell (DFC) 103. DFC 103 includes anode 105, cathode 107, anion exchange membrane (AEM) 109, and cation exchange membrane (CEM) 111. DFC 103 therefore has a two-membrane design, including one CEM, one AEM and one feedwater flow channel. AEM 109 is disposed between anode 105 and CEM 111. CEM 111 is disposed between cathode 107 and AEM 109. Flow channel 113 is formed between anode 105 and AEM 109. Flow channel 113 is configured for the flow of an anolyte and is also termed herein anolyte flow channel. Flow channel 115 is formed between cathode 107 and CEM 111. Flow channel 115 is configured for the flow of a catholyte and is also termed herein catholyte flow channel. Flow channel 117 is formed between AEM 109 and CEM 111. Flow channel 117 is configured for the flow of a feedwater and is also termed herein feedwater flow channel. The flow channels can be formed by disposing a gasket or spacer (not shown) between cathode 107 and CEM 111, between CEM 111 and AEM 109, and/or between AEM 109 and anode 105.

System 101 further includes tank 119 being in fluid flow connection through tubes 121a and 121b with anolyte flow channel 113. Tank 119 contains anolyte 123 and is thus also termed herein “anolyte tank”. During operation, anolyte 123 flows from tank 119 to the inlet of anolyte flow channel 113 through tube 121a and from the outlet of anolyte flow channel 113 to tank 119 through tube 121b (as shown by arrows within tubes 121a and 121b and anolyte flow channel 113). Anolyte 123 can be circulated through anolyte flow channel 113, anolyte tank 119, and tubes 121a and 121b by means of a pump (not shown).

System 101 further includes tank 125 being in fluid flow connection through tubes 127a and 127b with catholyte flow channel 115. Tank 125 contains catholyte 129 and is thus also termed herein “catholyte tank”. During operation, catholyte 129 flows from tank 125 to the inlet of catholyte flow channel 115 through tube 127a and from the outlet of catholyte flow channel 115 to tank 125 through tube 127b (as shown by arrows within tubes 127a and 127b and catholyte flow channel 115). Catholyte 129 can be circulated through catholyte flow channel 115, catholyte tank 125, and tubes 127a and 127b by means of a pump (not shown).

System 101 further includes tank 131 being in fluid flow connection through tubes 133a and 133b with feedwater flow channel 117. Tank 131 contains feedwater 135 and is thus also termed herein “feedwater tank”. During operation, feedwater 135 flows from tank 131 to the inlet of feedwater flow channel 117 through tube 133a and from the outlet of feedwater flow channel 117 to tank 131 through tube 133b (as shown by arrows within tubes 133a and 133b and feedwater flow channel 117). Feedwater 135 can be circulated through feedwater flow channel 117, feedwater tank 131, and tubes 133a and 133b by means of a pump (not shown). It is to be understood that while FIG. 1 depicts feedwater tank as an artificial storage tank, feedwater 135 can be supplied to feedwater flow channel 117 directly from a natural water reservoir. It should be further understood that while FIG. 1 depicts a close-loop circulation system, wherein feedwater 135 is returned to feedwater tank 131 after it passes through feedwater flow channel 117, open loop circulation is also encompassed by the methods and systems of the present invention, wherein feedwater 117 can be transferred to a deionized liquid tank and/or directly to a water supply system.

Anode 105 and cathode 107 are electrically connected via electric circuit 137 including electric load 139.

Anolyte 123 includes reductant R. Anolyte 123 further includes a product of an oxidation reaction of the reductant, R⁺. The anolyte can be in a form of an aqueous solution, in which R and/or R⁺ are dissolved. Catholyte 129 includes an oxidant O. Catholyte 129 further includes a product of a reduction reaction of the oxidant, O⁻. The catholyte can be in a form of an aqueous solution, in which O and/or O⁻ are dissolved. Oxidant O and reductant R do not carry electric charge.

During operation of system 101, reductant R is oxidized on anode 105, forming positively charged oxidation reaction product R⁺ and releasing electrons e⁻. Concentration of oxidation reaction product R⁺ in anolyte 123 in anolyte flow channel 113 is therefore increased. Electrons e⁻ are transferred from anode 105 to cathode 107 through electric circuit 137. When released, electrons e⁻ pass through electric circuit 137, electric power is generated, which can be consumed by electric load 139 (direction of electrons flow is shown by arrows within electric circuit 137). Oxidant O receives released electrons e⁻ and is reduced at cathode 107 to form negatively charged reduction reaction product O⁻. Concentration of reduction reaction product O⁻in catholyte 129 in catholyte flow channel 115 is also increased.

The method of deionization of a liquid according to the principles of the present invention therefore includes a discharge step. Said discharge step can be performed by connecting the DFC to an electric load and/or controlling by a designated operating system, for example, by controlling potential applied between the anode and the cathode or an electric current drawn from the DFC. As mentioned hereinabove, the electric current drawn from the DFC can be used to operate pumps, which flow feedwater, anolyte and/or catholyte through the DFC system.

Positively charged oxidation reaction product species R⁺ are blocked from passage from anolyte flow channel 113 to feedwater flow channel 117 by AEM 109. Negatively charged reduction reaction product species O⁻ are blocked from passage from catholyte flow channel 115 to feedwater flow channel 117 by CEM 111. In contrast to the blocking of the redox reaction products, AEM 109 allows passage of negatively charged feedwater ions (e.g., Cl⁻ ions) from feedwater flow channel 117 to anolyte flow channel 113 (direction of flow of Cl⁻ ions is shown by arrow which traverses AEM 109) and CEM 111 allows passage of positively charged feedwater ions (e.g., Na⁺ ions) from feedwater flow channel 117 to catholyte flow channel 115 (direction of flow of Na⁺ ions is shown by arrow which traverses CEM 111). Migration of the negatively charged feedwater ions to anolyte flow channel 113 is driven by the increase in the concentration of positively charged oxidation reaction product species R⁺ in anolyte flow channel 113. Similarly, migration of the positively charged feedwater ions to catholyte flow channel 115 is driven by the increase in the concentration of negatively charged reduction reaction product species O⁻ in catholyte flow channel 115. The increased positive charge of the aqueous solution of anolyte 123 is neutralized by the flow of the negatively charged ions from feedwater 135 in feedwater flow channel 117 and the increased negative charge of the aqueous solution of catholyte 129 is neutralized by the flow of the positively charged ions. The concentration of both the negatively charged and the positively charged ions in feedwater 135 in feedwater flow channel 117 is thereby decreased. The overall redox reaction between reductant R and oxidant O therefore not only produces electric power but also provides reduction in the concentration of ionic species in feedwater (i.e., deionization of feedwater).

Feedwater 135 is continuously circulated between feedwater tank 131 and feedwater flow channel 117, such that a portion of deionized feedwater is transferred from feedwater flow channel 117 to tank 135, thereby decreasing the total concentration of the ionic species in the total body of feedwater present in system 101. At the same time, new portion of freshwater 135 is being introduced to feedwater flow channel 117, thereby providing ions for balancing the charges in anolyte flow channel 113 and catholyte flow channel 115 and producing a new portion of deionized feedwater 139 in feedwater flow channel 117.

Anolyte 123 and catholyte 129 are also continuously circulated between anolyte tank 119 and anolyte flow channel 113, and between catholyte tank 125 and catholyte flow channel 115, respectively, thereby providing new reductant R and new oxidant O, which can undergo the redox reaction to produce electricity and further induce deionization process in the feedwater flow channel. In some embodiments, it is prerequisite that the total amount of reductant R and oxidant O is sufficient for providing the desired level of deionization in a single-step deionization process, without the need for replacing the anolyte and/or catholyte solution, removing the deionized feedwater, and/or supplying electricity to system DFC 103 (i.e., charging thereof). Accordingly, the method of deionization of a liquid according to some aspects and embodiments of the present invention does not include charging prior to or following the discharge step.

The rate and extent of the redox reaction can be controlled by a designated operating system, for example, by controlling potential applied between the anode and the cathode or an electric current drawn from the DFC.

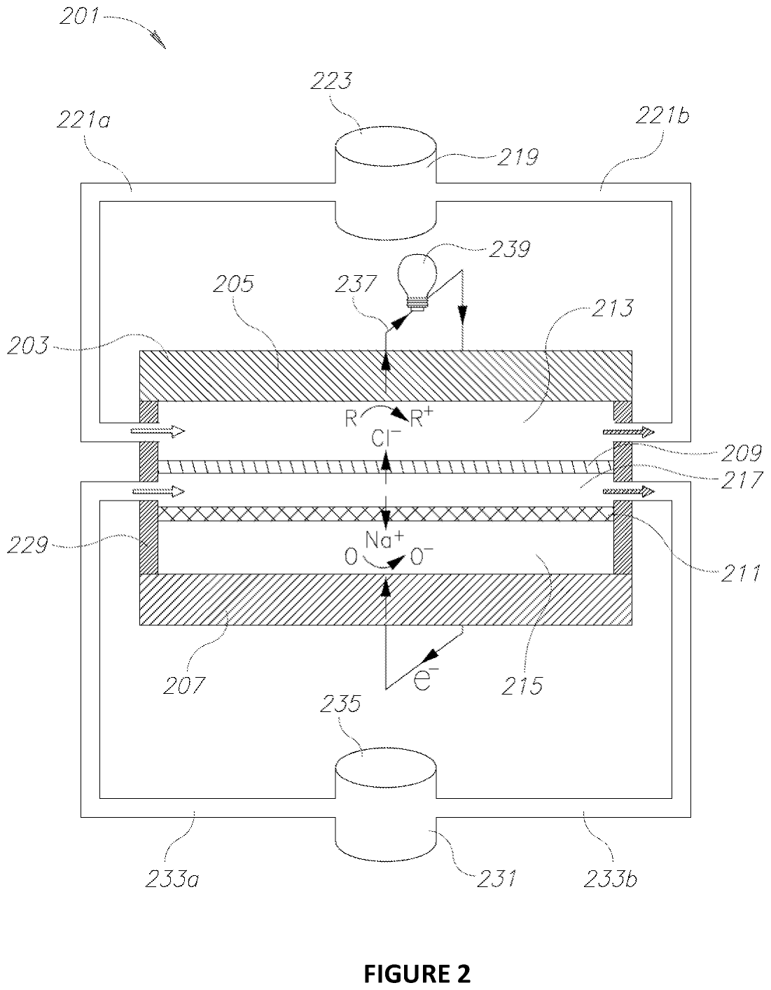

Reference is now made to FIG. 2, which schematically represents deionization fuel cell system 201, in accordance with some embodiments of the invention. Deionization fuel cell system 201 includes DFC 203. DFC 203 includes anode 205, cathode 207, AEM 209, and CEM 211.

AEM 209 is disposed between anode 205 and CEM 211. CEM 211 is disposed between cathode 207 and AEM 209. Flow channel 213 is formed between anode 205 and AEM 209. Flow channel 213 is configured for the flow of an anolyte and is also termed herein anolyte flow channel. Catholyte compartment 215 is formed between cathode 207 and CEM 211. Catholyte compartment 215 is configured to allow contact between oxidant O and cathode 211. In some embodiments, catholyte compartment 215 is configured to store catholyte 229, wherein the catholyte comprises oxidant O. In further embodiments, catholyte compartment 215 further includes a product of a reduction reaction of the oxidant, O⁻. Flow channel 217 is formed between AEM 209 and CEM 211. Flow channel 217 is configured for the flow of a feedwater and is also termed herein feedwater flow channel. The flow channels can be formed by disposing a gasket or spacer (not shown) between cathode 207 and CEM 211, between CEM 211 and AEM 209, and/or between AEM 209 and anode 205.

System 201 further includes tank 219 being in fluid flow connection through tubes 221a and 221b with anolyte flow channel 213. Tank 219 contains anolyte 223. During operation, anolyte 223 flows from tank 219 to the inlet of anolyte flow channel 213 through tube 221a and from the outlet of anolyte flow channel 213 to tank 219 through tube 221b (as shown by arrows within tubes 221a and 221b and anolyte flow channel 213). Anolyte 223 can be circulated through anolyte flow channel 213, anolyte tank 219, and tubes 221a and 221b by means of a pump (not shown).

System 201 further includes tank 231 being in fluid flow connection through tubes 233a and 233b with feedwater flow channel 217. Tank 231 contains feedwater 235. During operation, feedwater 235 flows from tank 231 to the inlet of feedwater flow channel 217 through tube 233a and from the outlet of feedwater flow channel 217 to tank 231 through tube 233b (as shown by arrows within tubes 233a and 233b and feedwater flow channel 217). Feedwater 235 can be circulated through feedwater flow channel 217, feedwater tank 231, and tubes 233a and 233b by means of a pump (not shown).

Anode 205 and cathode 207 are electrically connected via electric circuit 237 including electric load 239.

Anolyte 223 includes reductant R. Anolyte 223 further includes a product of an oxidation reaction of the reductant, R⁺.

The method of feedwater deionization utilizing system 201 is similar to system 101, depicted in FIG. 1, except that catholyte 229 is not circulated through DFC 203 but is stored inside said cell in catholyte compartment 215.

Alternatively, the deionization system can include anolyte compartment, in which the reductant is stored within the cell and a catholyte compartment, through which the catholyte is circulated.

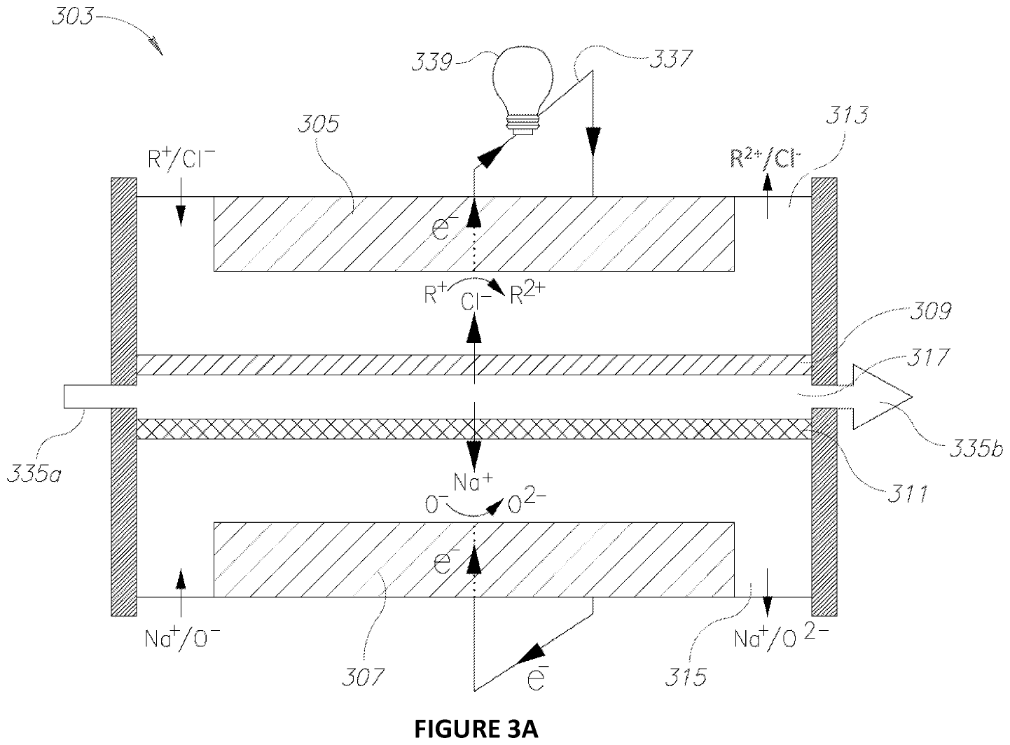

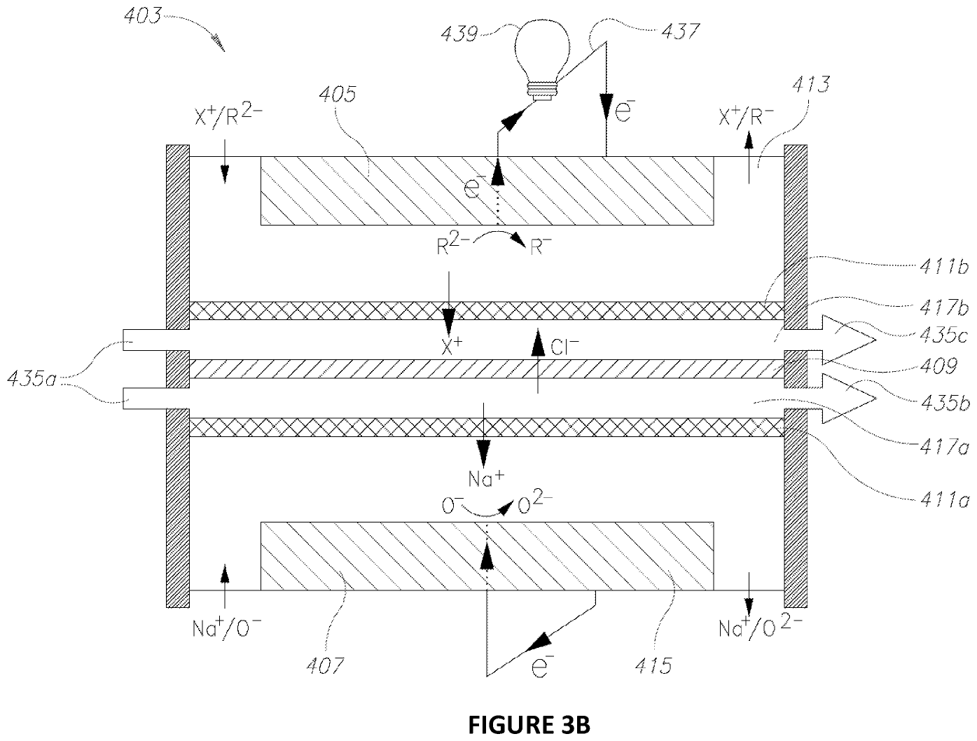

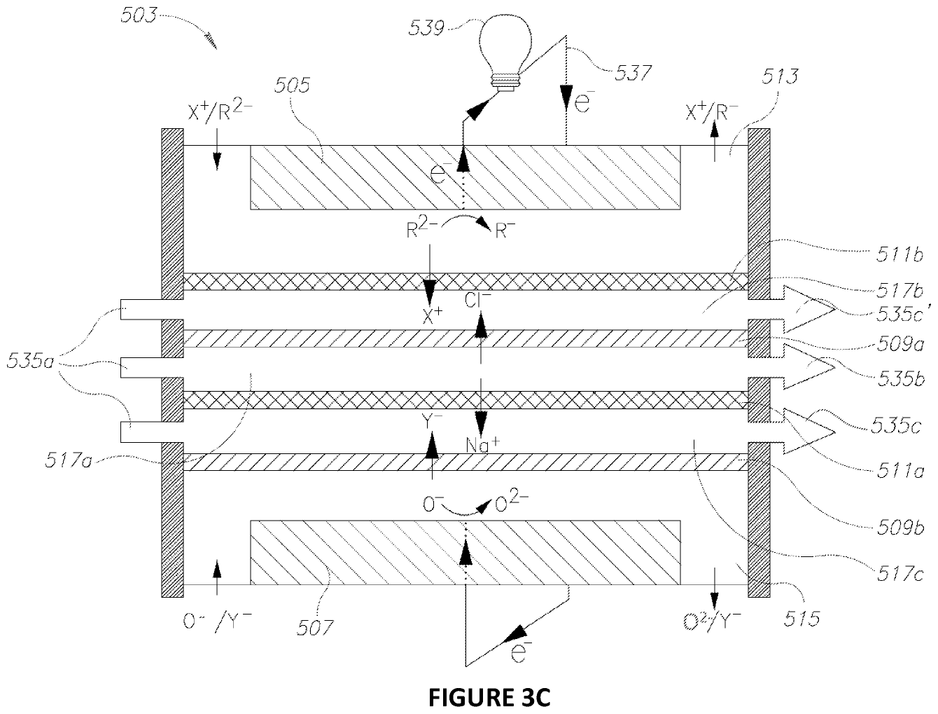

Reference is now made to FIG. 3A, which schematically represents DFC 303 comprising a positively charged reductant, and a negatively charged oxidant, according to some embodiments of the invention. DFC 303 includes anode 305 and cathode 307. DFC 303 has a two-membrane design, including one AEM 309, one CEM 311, anolyte flow channel 313, catholyte flow channel 315, and one feedwater flow channel 317, similarly to DFC 103 shown in FIG. 1. Anolyte flows through anolyte flow channel 313, as shown by arrows therewithin and catholyte flows through catholyte flow channel 315, as shown by arrows therewithin. Anode 305 and cathode 307 are electrically connected via electric circuit 337 including electric load 339 (direction of electrons flow is shown by arrows within electric circuit 337).

Since both the reductant and its oxidation reaction product are positively charged, they cannot pass AEM membrane 309 and flow from anolyte flow channel 313. Similarly, the negatively charged oxidant and its reduction reaction product cannot pass CEM 311 and flow from catholyte flow channel 315. Increase in the overall charge of the species in anolyte flow channel 313 and catholyte flow channel 315, as a result of the redox reaction, induces ion migration throughout DFC 303. In contrast to the blocking of the reductant, the oxidant, and the redox reaction products, AEM 309 allows passage of negatively charged feedwater ions (e.g., Cl⁻ ions) from feedwater flow channel 317 to anolyte flow channel 313 and CEM 311 allows passage of the positively charged feedwater ions (e.g., Na⁺ ions) from feedwater flow channel 317 to catholyte flow channel 315, therefore providing deionization of feedwater 335a to obtain desalted water 335b. Direction of flow of Cl⁻ ions is shown by arrow which traverses AEM 309 and direction of flow of Na⁺ ions is shown by arrow which traverses CEM 311.

According to some alternative embodiments, the reductant and/or its oxidation reaction product is negatively charged. In certain such embodiments, the reductant and/or its oxidation reaction product can pass AEM membrane 309 and flow from anolyte flow channel 313 to feedwater flow channel 317. In order for such system to allow water deionization in feedwater flow channel 317, the reductant and/or its oxidation reaction product should not increase concentration of the ions in feedwater flow channel 317. Such condition can be fulfilled by various system implementations and operational conditions. For example, concentration of the reductant or its oxidation reaction product can be kept low, in particular, as compared to the concentration of additional ions in anolyte flow channel 313, e.g., ions which are configured to increase ionic conductivity and/or ion strength of the anolyte. Such difference in the relative concentrations reduces and/or completely prevents the flow of the reductant and/or its oxidation reaction product from anolyte flow channel 313 through AEM 309 to feedwater flow channel 317. Additionally or alternatively, the reductant and/or its oxidation reaction product can be chosen such that they react with a certain ion in feedwater flow channel 317 to provide a neutral (uncharged) non-ionic compound.

According to some additional embodiments, the oxidant and/or its reduction reaction product are positively charged. In certain such embodiments, the oxidant and/or its reduction reaction product can pass CEM membrane 311 and flow from catholyte flow channel 315 to feedwater flow channel 317. In order for such system to allow water deionization in feedwater flow channel 317, the oxidant and/or its reduction reaction product should not increase concentration of the ions in feedwater flow channel 317. Such condition can be fulfilled by various system implementations and operational conditions. For example, concentration of the oxidant or its reduction reaction product can be kept low, in particular, as compared to the concentration of additional ions in catholyte flow channel 315, e.g., ions which are configured to increase ionic conductivity and/or ion strength of the catholyte. Such difference in the relative concentrations reduces and/or completely prevents the flow of the oxidant and/or its reduction reaction product from catholyte flow channel 315 through CEM 311 to feedwater flow channel 317. Additionally or alternatively, the oxidant and/or its reduction reaction product can be chosen such that they react with a certain ion in feedwater flow channel 317 to provide a neutral (not ionically charged) compound.

In some exemplary embodiments, the reductant is negatively charged and the oxidant is positively charged. In certain embodiments, DFC 303 comprises a hydrogen-oxygen cell, wherein the reductant comprises hydroxide ion and oxidant comprises a hydronium ion (or a proton). In additional embodiments, DFC 303 comprises an acid-base cell, wherein the reductant comprises hydroxide ion and oxidant comprises a hydronium ion (or a proton). In certain such embodiments, the hydroxide ions, which pass through AEM 309 to feedwater flow channel 317 react (or recombine) therein with the protons, which pass through CEM 311, resulting in the formation of neutral water molecules, which do not increase the concentration of ions in feedwater flow channel 317.

Reference is now made to FIG. 3B, which schematically represents DFC 403 comprising a negatively charged reductant, present in the anolyte, and a negatively charged oxidant, according to some embodiments of the invention. The anolyte further includes positively charged counterions (X⁺) which balance the overall charge of the anolyte prior to the operation of the DFC. DFC 403 includes anode 405 and cathode 407. DFC 403 has a three-membrane design, including first AEM 409, first CEM 411a, second CEM 411b, anolyte flow channel 413, catholyte flow channel 415, first feedwater flow channel 417a, and second feedwater flow channel 417b. First CEM 411a is disposed adjacently to cathode 407 and forms catholyte flow channel 415. Since the oxidant and its reduction reaction product are negatively charged, they cannot pass first CEM 411a and flow from catholyte flow channel 415. Second CEM 411b is disposed adjacently to anode 405 and forms anolyte flow channel 413. Since the reductant and its oxidation reaction product are negatively charged, they cannot pass the first CEM and flow from the anolyte flow channel. First AEM 409 is disposed between first CEM 411a and second CEM 411b. First feedwater flow channel 417a is formed between first CEM 411a and first AEM 409 and second feedwater flow channel 417b is formed between first AEM 409 and second CEM 411b. During the operation of the DFC, feedwater 435a is passed through first feedwater flow channel 417a and second feedwater flow channel 417b. Anolyte flows through anolyte flow channel 413, as shown by arrows therewithin and catholyte flows through catholyte flow channel 415, as shown by arrows therewithin. Anode 405 and cathode 407 are electrically connected via electric circuit 437 including electric load 439 (direction of electrons flow is shown by arrows within electric circuit 437).

Increase in the negative charge of the species in catholyte flow channel 415, as a result of the reduction reaction, induces ion migration throughout first CEM 411a. In contrast to the blocking of the oxidant and its reduction reaction product, first CEM 411a allows passage of the positively charged feedwater ions (e.g., Na⁺ ions) from first feedwater flow channel 417a to catholyte flow channel 415. Decrease in the negative charge of the species in anolyte flow channel 413, as a result of the oxidation reaction, induces ion migration throughout second CEM 411b. Second CEM 411b allows flow of the positively charged counterions from anolyte flow channel 413 to second feedwater flow channel 417b, to compensate for the induced charge gradient. Concentration of the positively charged ions in second feedwater flow channel 417b therefore is increased. First AEM 409 allows passage of negatively charged feedwater ions (e.g., Cl⁻ ions) from first feedwater flow channel 417a to second feedwater flow channel 417b, in order to balance said increase in the positive charge. Flow of the positively charged feedwater ions from first feedwater flow channel 417a to catholyte flow channel 415 and of the negatively charged feedwater ions from first feedwater flow channel 417a to second feedwater flow channel 417b therefore deionize feedwater 435a in first feedwater flow channel 417a to obtain desalted water 435b. In contrast, feedwater 435a in second feedwater flow channel 417b gets concentrated, thereby forming brine 435c, which can be collected in the brine tank (not shown) and disposed during or following the deionization process. Direction of flow of Cl⁻ ions is shown by arrow which traverses AEM 409 and direction of flow of Na⁺ ions is shown by arrow which traverses first CEM 411a.

Reference is now made to FIG. 3C, which schematically represents DFC 503 comprising a negatively charged reductant, present in the anolyte and a positively charged oxidant, present in the catholyte, according to some embodiments of the invention. The anolyte further includes positively charged counterions (X⁺) which balance the overall charge of the anolyte prior to the operation of DFC 503. The catholyte further includes negatively charged counterions (Y⁻) which balance the overall charge of the catholyte prior to the operation of DFC 503. DFC 503 includes anode 505 and cathode 507. DFC 503 has a four-membrane design, including first AEM 509a, second AEM 509b, first CEM 511a, second CEM 511b, anolyte flow channel 513, catholyte flow channel 515, first feedwater flow channel 517a, second feedwater flow channel 517b, and third feedwater flow channel 517c. Second AEM 509b is disposed adjacently to cathode 507 and forms catholyte flow channel 515. Since the oxidant and its reduction reaction product are positively charged, they cannot pass second AEM 509b and flow from catholyte flow channel 515. Second CEM 511b is disposed adjacently to anode 505 and forms anolyte flow channel 513. Since the reductant and its oxidation reaction product are negatively charged, they cannot pass first CEM 511a and flow from anolyte flow channel 513. First AEM 509a is disposed between first CEM 511a and second CEM 511b. First CEM 511a is disposed between first AEM 509a and second AEM 509b. First feedwater flow channel 517a is formed between first CEM 511a and first AEM 509a, second feedwater flow channel 517b is formed between the first AEM 509a and second CEM 511b, and third feedwater flow channel 517c is formed between first CEM 511a and second AEM 509b. During the operation of DFC 503, feedwater 535a is passed through the first, the second, and the third feedwater flow channels (517a, 517b, and 517c, respectively). Anolyte flows through anolyte flow channel 511, as shown by arrows therewithin and catholyte flows through catholyte flow channel 515, as shown by arrows therewithin. Anode 505 and cathode 507 are electrically connected via electric circuit 537 including electric load 539 (direction of electrons flow is shown by arrows within electric circuit 537).

Decrease in the positive charge of the species in catholyte flow channel 515, as a result of the reduction reaction, induces ion migration throughout second AEM 509b. In contrast to the blocking of the oxidant and its reduction reaction product, second AEM 509b allows passage of the negatively charged counterions from catholyte flow channel 515 to third feedwater flow channel 517c, to compensate for the induced charge gradient. Concentration of the negatively charged ions in third feedwater flow channel 517c is therefore increased. Second AEM 509b allows passage of the positively charged feedwater ions (e.g., Na⁺ ions) from first feedwater flow channel 517a to third feedwater flow channel 517c, in order to balance said increase in the negative charge. Decrease in the negative charge of the species in anolyte flow channel 513, as a result of the oxidation reaction, induces ion migration throughout second CEM 511b. Second CEM 511b allows flow of the positively charged counterions from anolyte flow channel 513 to second feedwater flow channel 517b, to compensate for the induced charge gradient. Concentration of the positively charged ions in second feedwater flow channel 517b is therefore increased. First AEM 509a allows passage of negatively charged feedwater ions (e.g., Cl⁻ ions) from first feedwater flow channel 517a to second feedwater flow channel 517b, in order to balance said increase in the positive charge. Flow of the positively charged feedwater ions from first feedwater flow channel 517a to third feedwater flow channel 517c and of the negatively charged feedwater ions from first feedwater flow channel 517a to the second feedwater flow channel 517b therefore deionize feedwater 535a in first feedwater flow channel 517a to obtain desalted water 535b. In contrast, feedwater 535a in second feedwater flow channel 517b and third feedwater flow channel 517c gets concentrated, thereby forming brine 535c′ and 535c, respectively, which can be collected in the brine tank (not shown) and disposed during or following the deionization process. Direction of flow of Cl⁻ ions is shown by arrow which traverses first AEM 509a and direction of flow of Na⁺ ions is shown by arrow which traverses first CEM 511a.

As mentioned hereinabove, the deionization method includes a discharge step. Discharge of the DFC can be performed by connecting the DFC to electric load and/or drawing a predefined electric current from the DFC. In some embodiments, the DFC is discharged at the current density of at least about 1 mA/cm². In further embodiments, the DFC is discharged at the current density of at least about 2 mA/cm². In yet further embodiments, the DFC is discharged at the current density of at least about 5 mA/cm². In still further embodiments, the DFC is discharged at the current density of at least about 10 mA/cm². In yet further embodiments, the DFC is discharged at the current density of at least about 15 mA/cm².

In some embodiments, the DFC is discharged at the current density of below about 15 mA/cm². In further embodiments, the DFC is discharged at the current density of below about 10 mA/cm². In still further embodiments, the DFC is discharged at the current density of below about 5 mA/cm².

It should be emphasized that the method of deionization does not require a step of charging the DFC prior to or following the discharge step. Accordingly, in some currently preferred embodiments, the method of deionization does not include a step of charging the DFC prior to or following the discharge step. In certain embodiments, the DFC is not rechargeable. According to some embodiments, the step of passing the feedwater through the DFC system comprises passing the feedwater through the first feedwater flow channel. In further embodiments, the feedwater is continuously cycled through the first feedwater flow channel.

According to additional embodiments, the step of passing the feedwater through the DFC system comprises passing the feedwater through each one of the feedwater flow channels, including, inter alia, the first feedwater flow channel, the second feedwater flow channel and the third feedwater flow channel. In certain embodiments, the step of passing the feedwater through the DFC system comprises continuously cycling the feedwater between the feedwater tank and the first feedwater flow channel, while the feedwater supplied to the second and third feedwater flow channels from the feedwater tank is continuously collected after it has passed through said channels and transferred to the brine tank.

According to some embodiments, the method of deionization further comprises a step of passing a catholyte through the catholyte flow channel. Additionally or alternatively the method of deionization can further comprise a step of passing an anolyte through the anolyte flow channel. In further embodiments, the catholyte is continuously cycled through the catholyte flow channel and/or the anolyte is continuously cycled through the anolyte flow channel.

The feedwater, the anolyte and/or the catholyte can be circulated through the DFC by using one or more pumps. Non-limiting examples of suitable pumps include peristaltic pump, piston pump, electroosmotic pump, positive displacement pump, or gravitational pumping. The rate of the catholyte, anolyte and/or feedwater flow through the respective flow channels can be controlled by said one or more pumps.

In some embodiments, the flow rate of the catholyte and/or anolyte is at least two-fold higher than the flow rate of the feedwater. In further embodiments, the flow rate of the catholyte and/or anolyte is about three-fold higher than the flow rate of the feedwater.

According to some embodiments, the method of deionization further comprises filling the feedwater tank with the feedwater to be deionized. In further embodiments, the method of deionization comprises filling at least one of the catholyte tank and the anolyte tank with the catholyte and the anolyte, respectively, prior to the discharge step. In some embodiments, the method of deionization further comprises adding a new portion of the oxidant to the catholyte and/or a new portion of the reductant to the anolyte following the discharge step.

According to some embodiments, the method of deionization further comprises a step of supplying the oxidant and/or reductant from outside the DFC. In some embodiments, the oxidant, e.g., air, is provided from the DFC ambiance. In some related embodiments, the cathode is configured to transport air to the interface with the catholyte. The cathode can include a gas diffusion layer to facilitate air transport. An endplate enclosing the cathode can be designed to allow air passage therethrough. According to some embodiments, the method of deionization comprises flowing oxygen gas to the DFC cathode. According to some embodiments, the method of deionization comprises flowing hydrogen gas to the DFC anode. The gases can be supplied from storage tanks, electrolyzer, or in any other manner, as known in the art. Preferably, the cathode and/or the anode include a gas diffusion layer to facilitate gas transport therethrough.

The DFC system of the present invention can be used for deionization of seawater, brackish water, hard water, wastewater or organic streams without being connected to power grid. Accordingly, in some embodiments, the system and method of the invention are configured for use in off-grid locations. In additional embodiments, the system and method of the invention are configured for use in city-level deionization. Due to the high power and deionization efficiency of the present system and method, the DFC does not require coupling to a reverse osmosis system to provide the desired level of deionization.

As used herein and in the appended claims the singular forms “a”, “an,” and “the” include plural references unless the content clearly dictates otherwise. Thus, for example, reference to “an ion” includes a plurality of such ions. It should be noted that the term “and” or the term “or” is generally employed in its sense including “and/or” unless the content clearly dictates otherwise.

As used herein, the term “about”, when referring to a measurable value such as an amount, a temporal duration, and the like, is meant to encompass variations of +/−20%, more preferably +/−5%, even more preferably +/−1%, and still more preferably +/−0.1% from the specified value, as such variations are appropriate to perform the disclosed methods.

The term “plurality,” as used herein, means two or more.

The following examples are presented in order to more fully illustrate some embodiments of the invention. They should, in no way be construed, however, as limiting the broad scope of the invention. One skilled in the art can readily devise many variations and modifications of the principles disclosed herein without departing from the scope of the invention.

### EXAMPLES

### Example 1—Construction of zinc-bromine DFC System

Zinc-bromine DFC contained a custom-milled planar graphite cathode, custom-cut 0.127 mm thick titanium sheet current collector at the cathode side and 0.62 mm thick zinc sheet for the anode (Alfa Aesar, United Kingdom), Viton rubber gaskets, and Neosepta ion exchange membranes (Neosepta AMX and CMX, Tokuyama, Japan). The endplates used were acrylic for the zinc side and PVDF for the bromine side. The anolyte and catholyte flow channels were made by cutting 6.7 by 1.5 cm channels into 1 mm thick Viton rubber gaskets, and stacking two gaskets per flow channel (flow channel thickness was 2 mm). Thus, the active area of the DFC used for current normalization was that of the anolyte and catholyte flow channels, which was 10 cm². The deionization channel was cut into a single 1 mm Viton rubber gasket with the channel dimensions of 12.5 by 1.5 cm. The feedwater flow channel was longer than the anolyte and catholyte flow channels in order to allow for convenient injection and removal of the feedwater from the cell. The cell was sealed with fourteen M4, 48 mm long stainless-steel bolts, which were plastic wrapped to prevent internal short circuiting. The connection to an external load was made through tabs on the titanium and zinc metal sheets.

The DFC system further included three storage tanks connected to the catholyte flow channel, the anolyte flow channel and the feedwater flow channel and three peristaltic pumps (Masterflex, Cole Parmer, USA), for the flow of the catholyte, anolyte and feedwater.

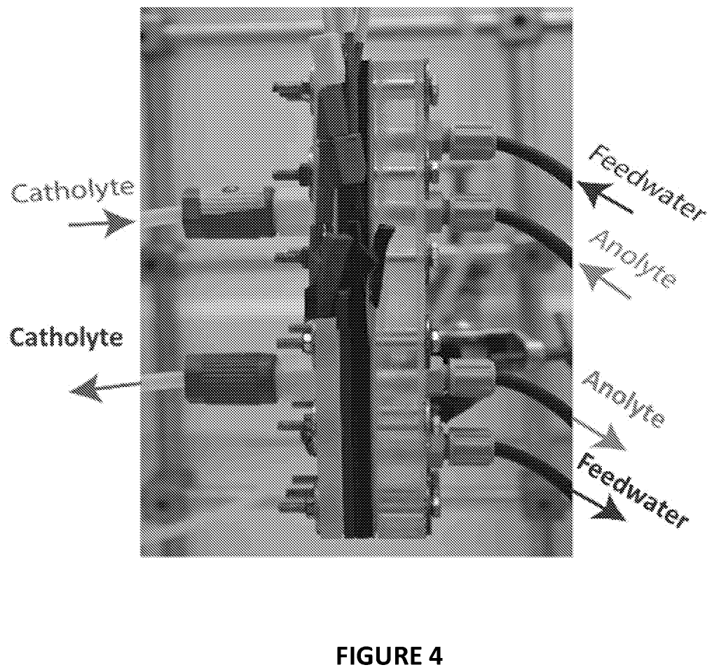

FIG. 4 shows the experimental DFC with a 10 cm² active area.

### Example 2—Operation of zinc-bromine DFC System

The zinc-bromine DFC, which construction is detailed in Example 1, was operated as follows:

The anolyte was prepared by mixing zinc chloride salt into deionized water to form 1 L of 2 M ZnCl₂. For the catholyte, bromine and sodium bromide salt were mixed into deionized water to 1 L of 1 M Br₂/2 M NaBr. In the catholyte, the bromine and bromide complex form negatively charged tribromide, which is the dominant oxidant species. The relatively large volume of anolyte and catholyte was chosen in order to maintain an approximately constant state of charge throughout a series of deionization experiments. The feedwater was prepared by adding NaCl to 30 mL of deionized water to create a 500 mM (29.22 g/L) NaCl solution.

All three solutions, including anolyte, catholyte and feedwater were recirculated through the cell using the peristaltic pumps at a flow rate of 0.5 mL/min for the feedwater and 1.5 mL/min for the anolyte and 2 mL/min for the catholyte. During polarization curve measurements (FIG. 2a), a constant current was delivered from the cell to a potentiostat in steps of 1 mA/cm² (Biologic VSP, France), with a dwell time of at least 5 min per step to attain the equilibrium cell voltage. Also, for polarization curve measurements, the feedwater volume used was 1 L instead of 30 mL to achieve a steady state salt concentration in the deionization channel. For the constant current experiments (FIG. 2b-d), the DFC delivered currents ranging from 2 to 16 mA/cm², while flow was maintained in all channels. During these experiments, two parameters were evaluated: the resulting cell voltage and the effluent conductivity leaving the deionization channel (Tracedec, Innovative Sensor Technologies GmbH, Austria). Conductivity was converted to NaCl concentration via a prepared calibration curve. Constant current experiments continued until cell voltage reached below 0.5 V, at which point the experiment ended.

### Example 3—Deionization Efficiency of zinc-bromine DFC System

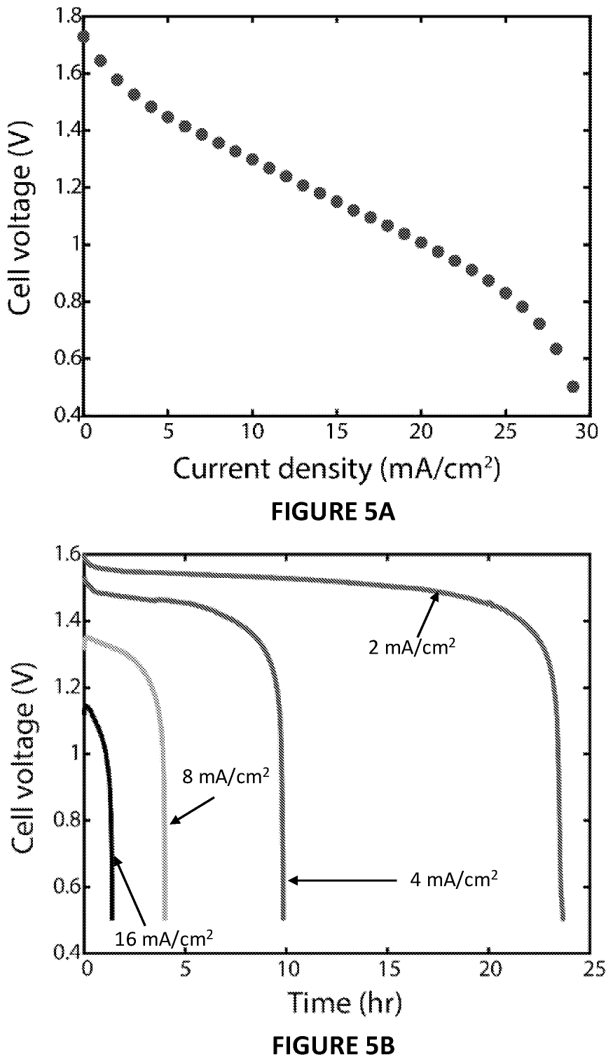

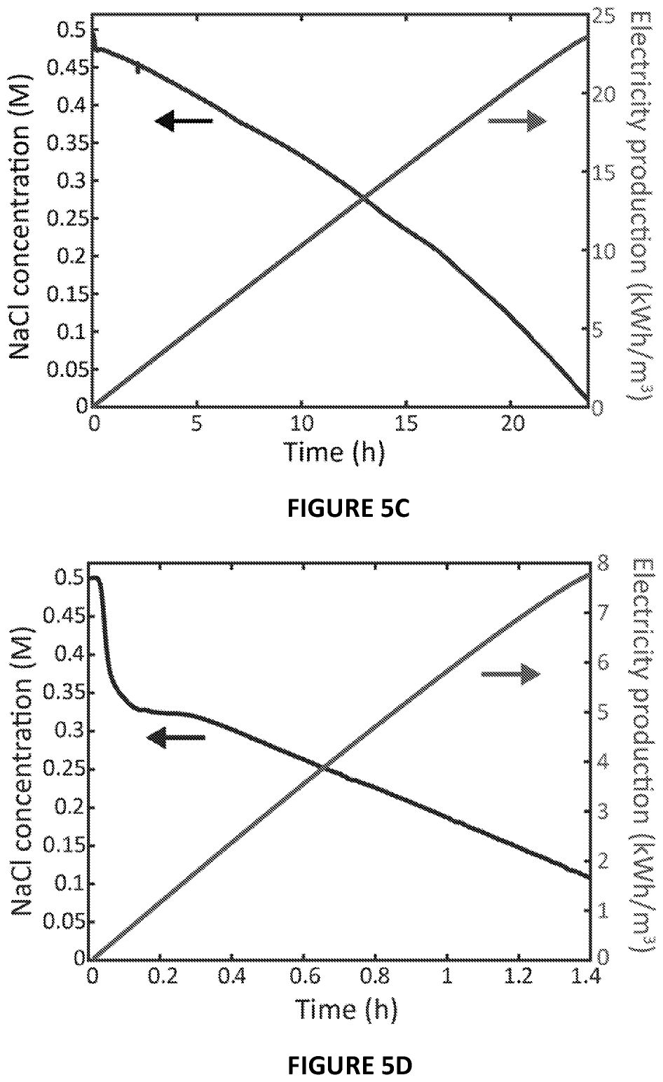

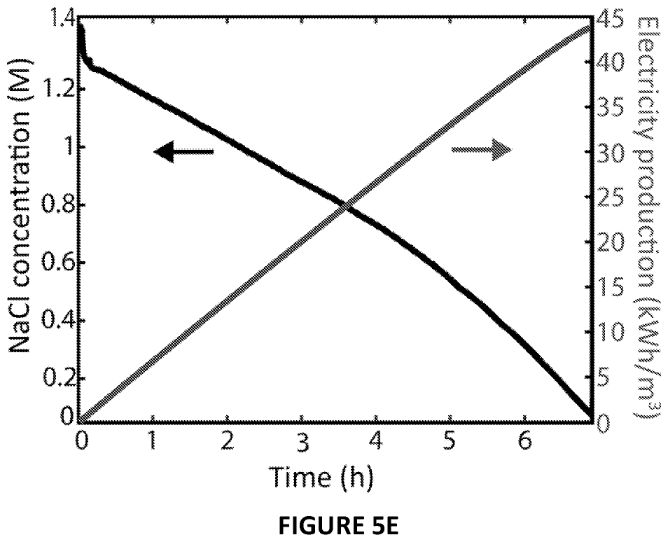

The zinc-bromine DFC was constructed and operated as described in Examples 1 and 2, respectively. FIG. 5A depicts the measured polarization curve for the DFC, by plotting measured equilibrium cell voltage versus set current. From this figure, it can be observed that the cell's open circuit voltage (OCV) is measured to be about 1.74 V. A distinct activation region can be observed at lower currents, until about 5 mA/cm², after which a linear Ohmic region is observed until about 25 mA/cm². At higher currents, significant mass transport limitations are observed, with a limiting current at about 30 mA/cm². Such a limiting current density is roughly an order of magnitude lower than that observed for electrochemical cells with planar electrodes which are limited by bromine reduction, for similar bromine concentration (W. A. Braff, M. Z. Bazant and C. R. Buie, Nat. Commun., 2014, 4, 2346). Without wishing to being bound by theory, this suggests that the limiting current observed is not due to reactant exhaustion at the cathode, but rather that the salt concentration in the deionization channel approaches zero at the membrane surface.

FIGS. 3B-3D show results of constant current experiments. FIG. 5B shows the measured voltage from the DFC when extracting currents from 2 to 16 mA/cm². As can be seen, setting a higher current resulted in a lower cell voltage, as is typical of fuel cell performance. Each experiment was run until the cell voltage fell to 0.5 V, which was attained via rapid voltage decay at the end of all curves shown in FIG. 3B. At the lower currents tested (2 and 4 mA/cm²), a relatively stable cell voltage was obtained, where cell voltage decreases slowly as the middle channel is desalted. The relatively stable voltage lasts for several hours until the cell voltage suddenly drops (at about 24 hrs for 2 mA/cm² and about 10 hrs for 4 mA/cm²). The sudden drop in cell voltage coincides with the near complete deionization of the middle channel (FIG. 5C). When running the cell at the highest current of 16 mA/cm², the cell died roughly 1.5 hours into the experiment, without reaching a stable voltage.

FIG. 5C depicts the measured concentration of the effluent leaving the deionization channel of the cell, and the cumulative electricity produced by the cell during an experiment at an extracted current of 2 mA/cm². The conductivity data was taken simultaneously with the voltage data of FIG. 5B. The initial concentration of the salty water pumped through the middle channel was 500 mM NaCl, which is approximately the salinity level of seawater. At the start of the experiment, a quick reduction to about 470 mM is observed within the first 10 min, followed by slower and fairly steady salt removal as the salt water is recirculated through the deionization channel of the cell. Salt removal continued until the salt concentration reached about 10 mM at 24 h, at which point the cell voltage fell quickly to 0.5 V and the experiment ended (FIG. 5B). Thus, the total salt concentration reduction was nearly two orders of magnitude during the 2 mA/cm² experiment. Electricity was produced by the cell during deionization, which can be calculated by the integral in time of cell voltage shown in FIG. 5B multiplied by the extracted current. In FIG. 5C, it can be seen that the cumulative electricity produced by the cell, which is roughly linear in time due to the near constant voltage of the cell during most of the experiment (FIG. 5B). The total electricity delivered by the cell during deionization was about 0.7 Wh, or 23.5 kWh/m³ when normalized by the volume of desalted water (30 mL). FIG. 5D shows the salt concentration and energy produced for an extracted current of 16 mA/cm². Upon beginning the experiment, a distinct sharp drop in salt concentration to 350 mM is observed within about 10 min, similar to the initial transient seen at 2 mA/cm², but significantly stronger. After this initial transient, salt removal proceeds at a much faster rate relative to FIG. 5C, until the cell voltage suddenly drops to 0.5 V at about 1.4 h (FIG. 5B). As can be seen in FIG. 5D, the cell died before the middle channel was completely desalted, as at the end of the experiment the salt concentration was just above 100 mM. The latter points to a potentially important role of mass transport boundary layers in the deionization channel on the cell deionization performance. Likely the salt concentration at the membranes in the deionization channel approached zero even with a bulk salt concentration of about 100 mM, causing the observed sharp drop in cell voltage (FIG. 5B). Total electricity production during deionization at 16 mA/cm² was noticeably lower than for 2 mA/cm², and was about 0.23 Wh. Overall, the results of FIGS. 5C and 5D demonstrate that the extracted current density must be carefully chosen if complete deionization is desired, and that there is a trade-off between electricity delivered during deionization and deionization rate (current density). Furthermore, the initial DFC tested here can attain order of magnitude higher deionization current densities relative to deionization batteries, which are thus far restricted to roughly 1 mA/cm² (S. Porada, A. Shrivastava, P. Bukowska, P. M. Biesheuvel and K. C. Smith, Electrochim. Acta, 2017, 255, 369-378; D. Nam and K. Choi, J. Am. Chem. Soc., 2017, 139, 11055-11063).

FIG. 5E shows a measured feedwater flow channel effluent concentration and cumulative energy production by the DFC during deionization of 1.5M NaCl at 16 mA/cm². It can be seen that the DFC can desalt 1.5 M NaCl streams to concentrations as low as about 0.1 M.

### Example 4—Energy- and Cost-Efficiency of zinc-bromine DFC System

In FIGS. 5A-5D, the basic concept of the zinc-bromine DFC was demonstrated, showing its ability to deliver desalted water and electricity without requiring an electricity input. To further analyze the DFC, a methodology was developed to understand the energy efficiency and cost proposition of the DFC towards sea water deionization. When a DFC system is combined with a chemical production plant supplying the needed redox active chemicals, the main energy flows are the chemical energy input to the DFC from the plant, (kWh/m³)_{chem}, and the electrical energy output from the DFC during deionization, (kWh/m³)_{elect}, both per m³ of desalted water. The energy input to the DFC can be calculated as the electricity produced if the cell voltage remains at its OCV for the entire deionization process, and this process has the same duration as that shown in FIG. 5B. This input energy can also be interpreted as the electricity produced during a hypothetical lossless conversion of chemical-to-electrical energy (when there are no finite resistances in the DFC). In this analysis, energy losses due to reactant crossover through the membranes were neglected, as this loss mechanism is expected to be small relative to energy loss via resistive dissipation. An energy recovery efficiency can be thus defined as the ratio of the electricity output of the DFC during deionization to the input chemical energy.

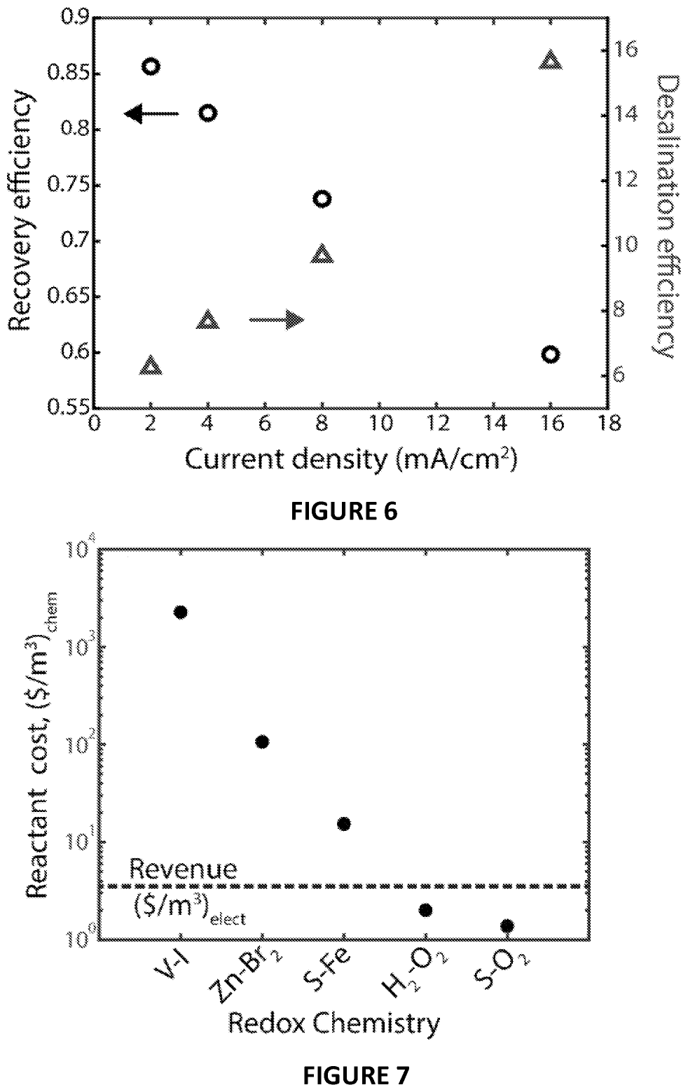

FIG. 6 depicts a plot of the measured energy recovery efficiency, showing that the DFC can recover up to 85% of the input energy when operated at 2 mA/cm², and thus 15% of the input energy was used to drive the deionization process. This recovery occurs without any dedicated energy recovery device, as electricity is naturally outputted by the DFC during operation. Recovery efficiency decreases with increasing current density, as is expected as higher currents represent further departures from equilibrium, and drops to 60% at 16 mA/cm².

To gain additional insight, the energy used to drive deionization in the DFC,) (kWh/m³)_{chem}-(kWh/m³)_{elect}, can be compared to the calculated thermodynamic minimum energy requirement for desalting a 500 mM NaCl feedwater, ΔGₛₑₚ (M. Elimelech and W. A. Phillip, Science, 2011, 333, 712-717, N. Y. Yip and M. Elimelech, Environ. Sci. Technol., 2012, 46, 5230-5239). The energy used to drive deionization is measured to be 3.9 kWh/m³ at 2 mA/cm², and increases with applied current to 5.2 kWh/m³ at 16 mA/cm². The minimum energy, ΔGₛₑₚ, is calculated assuming a thermodynamically reversible separation process, and thus is unachievable in practice and independent of the technology used to perform the deionization. The calculation was performed for 1.5% water recovery, as this was the ratio of feedwater volume to anolyte and catholyte volume in the DFC system was low. The calculated minimum thermodynamic energy ranges from about 0.33 to 0.63 kWh/m³, because of the range of desalted water concentration achieved at the end of the deionization experiments FIGS. 5C and 5D). The ratio of energy used to drive deionization to the thermodynamic minimum energy for deionization is 6.3 at 2 mA/cm² (FIG. 6), demonstrating that the DFC system is highly energy efficient at performing seawater deionization. This is in stark contrast to other, widely-used electrochemical systems for water deionization, such as electrodialysis and capacitive deionization, which are largely inefficient at sea water deionization and thus are restricted to brackish water feeds. Even higher energy efficiencies can be achieved by running the device at lower currents densities, while still remaining within practical process time frames.

The energy flows during DFC operation are also associated with monetary value, mainly the cost of the reactants used to drive the cell and the income from electricity produced by the cell. The estimated cost of a reactant per m³ of seawater desalinated can be calculated as:

QMp/nF, Equation (10)

where Q is the ionic charge in Coulombs per m³ of feedwater, M is the reactant molar mass, F is Faraday's constant, n is the moles of electrons per mole of reactant, and p is the reactant price in units of $/kg. FIG. 7 shows the calculated cost of reactants in units $/m³, for various chemistries which are compatible with the DFC according to the principles of the present invention, having two- three- or four-membrane design. The cost of reactants for a given DFC requires summing the cost per m³ of both the reductant and oxidant used in the proposed DFC. As can be seen, chemistries utilizing low-cost sulfur, hydrogen, or iron, and those that are air-breathing, demonstrate highly promising cost propositions, with reactant cost achieving the order of $1/m³. To gain a more complete estimate of the operational cost of desalted water when using a DFC, the revenue resulting from the generated electricity should be subtracted from the reactant costs. As shown in FIG. 5C, when desalting seawater with the zinc-bromine DFC, 23.5 kWh/m³ energy is generated, and at an electricity cost of $0.15/kWh the DFC provides about $3.5/m³ of revenue (dashed line in FIG. 7). The cost analysis provided herein demonstrates that low-cost reactant DFCs can provide ultra-low cost desalted water.

### Example 5—Hydrogen-oxygen DFC System

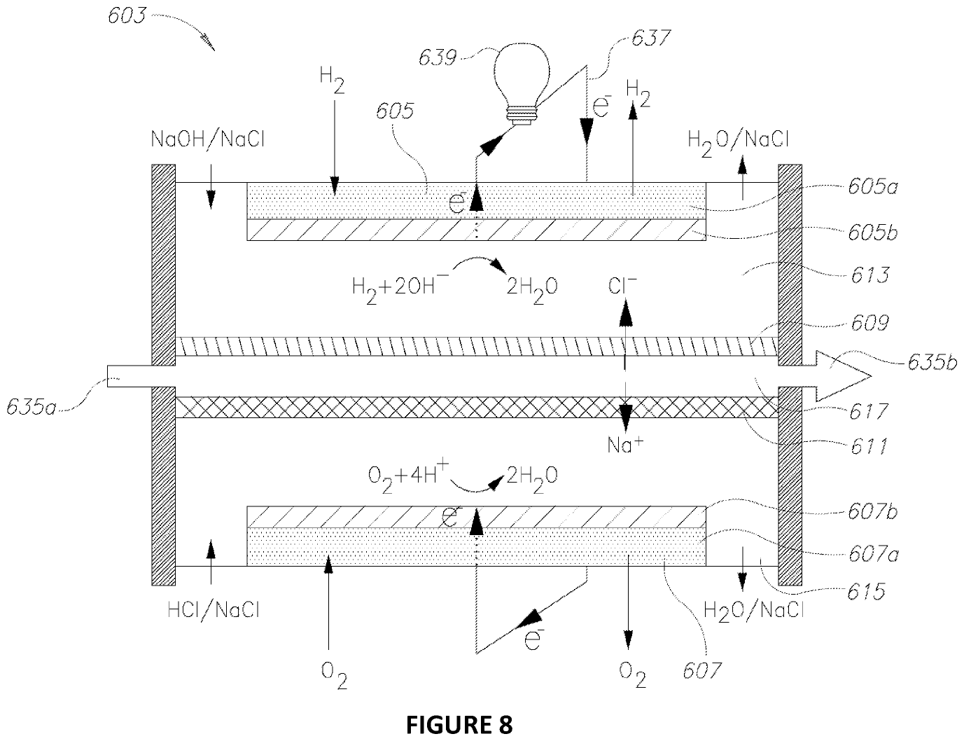

FIG. 8 schematically represents hydrogen-oxygen DFC 603 (which is a dual electrolyte hydrogen-oxygen fuel cell), according to some embodiments of the invention. DFC 603 includes anode 605, which contains gas diffusion layer (GDL) 605a and catalytic layer 605b. DFC 603 further includes cathode 607, which contains GDL 607a and catalytic layer 607b. DFC 603 has a two-membrane design, including one AEM 609, one CEM 611, anolyte flow channel 613, catholyte flow channel 615, and one feedwater flow channel 617, similarly to DFC 303 shown in FIG. 3A. Anolyte contains hydroxyl ions (i.e., is alkaline) and hydrogen is flown to anode 605 through GDL 605a. Catholyte contains hydronium ions (i.e., is acidic) and oxygen is flown to cathode 607 through GDL 607a. Anolyte flows through anolyte flow channel 613, as shown by arrows therewithin and catholyte flows through catholyte flow channel 615, as shown by arrows therewithin. Anode 605 and cathode 607 are electrically connected via electric circuit 637 including electric load 639 (direction of electrons flow is shown by arrows within electric circuit 637).

Increase in the overall charge of the species in anolyte flow channel 613 and catholyte flow channel 615, as a result of the hydrogen-oxygen redox reaction (Equations 4-6), induces ion migration throughout DFC 603. AEM 609 allows passage of negatively charged feedwater ions (e.g., Cl⁻ ions) from feedwater flow channel 617 to anolyte flow channel 613 and CEM 611 allows passage of the positively charged feedwater ions (e.g., Na⁺ ions) from feedwater flow channel 617 to catholyte flow channel 615, therefore providing deionization of feedwater 635a to obtain desalted water 635b. Direction of flow of Cl⁻ ions is shown by arrow which traverses AEM 609 and direction of flow of Na⁺ ions is shown by arrow which traverses CEM 611.

While the reductant (hydroxide ion) is negatively charged and, theoretically, can pass AEM 609 and flow from anolyte flow channel 613, operational conditions of the cell can be adjusted such that its flow to feedwater flow channel 617 is kept to a minimum or completely prevented. The same applies to the oxidant (hydronium ion or proton), which is positively charged and, theoretically, can pass CEM 611 and flow from catholyte flow channel 615. Operational conditions of the cell can be adjusted such that the flow of the protons to feedwater flow channel 617 is kept to a minimum or completely prevented. Additionally, even if hydroxyl ions and protons flow to feedwater flow channel 617, they recombine in feedwater flow channel 617 in a neutralization reaction to form water and do not increase the ionic concentration of the feedwater effluent.

### Example 6—Construction of hydrogen-oxygen DFC System

Hydrogen-oxygen DFC contained a custom-milled planar graphite current collectors, 2 mg/cm² platinum black carbon cloth electrode (Fuel cell store, Texas, USA) at the cathode side and 0.5 mg/cm² 60% Pt on Vulcan carbon cloth electrode (Fuel cell store, Texas, USA) at the anode side, Viton rubber gaskets, and Neosepta ion exchange membranes (Neosepta AMX and CMX, Tokuyama, Japan). The endplates used were PVDF. The anolyte and catholyte flow channels were made by cutting 10.5 by 1.5 cm channels into 1 mm thick Viton rubber gaskets, and stacking two gaskets per flow channel (flow channel thickness was 2 mm), the desalination channel was cut into a single 1 mm Viton rubber gasket with the channel dimensions of 10.5 by 1.5 cm. Thus, the active area of our DFC used for current normalization was 15.75 cm². The graphite current collectors were machined to get flow-fields for the gases, a 1 mm wide channel was etched along the active area. The cell was sealed with fourteen M4, 48 mm long stainless-steel bolts, which were plastic wrapped to prevent internal short circuiting. The connection to an external load was made through tabs on the graphite current collectors.

The DFC system further included three storage tanks connected to the catholyte flow channel, the anolyte flow channel and the feedwater flow channel and three peristaltic pumps (Masterflex, Cole Parmer, USA), for the flow of the catholyte, anolyte and feedwater.

### Example 7—Operation of hydrogen-oxygen DFC System

The hydrogen-oxygen DFC, which construction is detailed in Example 6, was operated as follows:

The anolyte was prepared by mixing sodium chloride and sodium hydroxide salts into deionized water to form 1 L of 1 mM NaOH/0.5 M NaCl. For the catholyte, hydrochloric acid and sodium chloride salt were mixed into deionized water to form 1 L of 1 mM HCl/0.5 M NaCl. The relatively large volume of anolyte and catholyte was chosen in order to maintain an approximately constant state of charge throughout a series of desalination experiments. Without wishing to being bound by theory or mechanism of action, the relatively low concentration of NaOH and HCl, in particular, as compared to the concentration of NaCl, reduces the probability of their crossover to the feedwater flow channel through AEM and CEM, respectively. The feedwater was prepared by adding NaCl to 30 mL of deionized water to create a 500 mM (29.22 g/L) NaCl solution. pure oxygen and hydrogen gases were flowed to the cell, the oxygen gas was at the cathode side and the hydrogen gas at the anode side.

All three solutions, including anolyte, catholyte and feedwater were recirculated through the cell using the peristaltic pumps at a flow rate of 1 mL/min for the feedwater and 1.5 mL/min for the anolyte and catholyte. During polarization curve measurements (FIG. 1), a constant current was delivered from the cell to a potentiostat in steps of 0.6 mA/cm² (Biologic VSP, France), with a dwell time of at least 5 min per step to attain the equilibrium cell voltage. Also, for polarization curve measurements, the feedwater volume used was 1 L to achieve a steady state salt concentration in the desalination channel. During these experiments, two parameters were evaluated: the resulting cell voltage and the effluent conductivity leaving the desalination channel (Tracedec, Innovative Sensor Technologies GmbH, Austria). Conductivity was converted to NaCl concentration via a prepared calibration curve.

### Example 8—Desalination Efficiency of hydrogen-oxygen DFC System

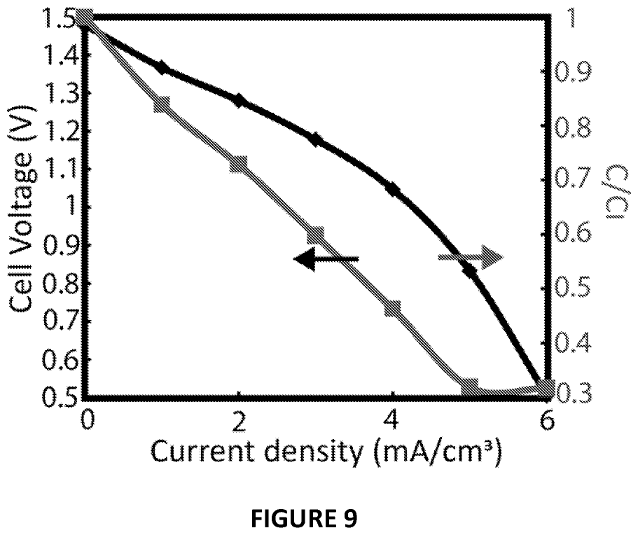

The oxygen-hydrogen DFC was constructed and operated as described in Examples 6 and 7, respectively. FIG. 9 depicts the measured polarization curve for the DFC, by plotting measured equilibrium cell voltage versus set current density. It can be observed that the cell's open circuit voltage is measured to be about 1.5 V. A distinct activation region can be observed at lower currents, up to about 1 mA/cm², after which a linear Ohmic region is observed up to about 4 mA/cm². At higher currents, significant mass transport limitations are observed, with a limiting current of about 6 mA/cm². FIG. 9 also shows the measured concentration of the effluent leaving the desalination channel of the cell during the polarization curve experiment, normalized by the initial concentration of the feedwater (500 mM NaCl), to the set current density. The conductivity data was taken simultaneously with the voltage data. The initial concentration of the salty water pumped through the middle channel was 500 mM NaCl, which is approximately the salinity level of seawater. By drawing a current from the cell, the concentration of the effluent leaving the desalination channel was reduced. Drawing higher currents led to further reduction in the concentration, until reaching the limiting current in which the experiment ended and the concentration reached about one third of the initial concentration. Circulating the feedwater flow channel effluent at lower flowrates can lead to lower concentration of the effluent at the output.

It has further been found that the pH of the anolyte and catholyte is generally relatively steady between the inlet and outlet of the anolyte and catholyte flow channel, respectively. It can therefore be concluded that there is no significant flow of the hydroxyl ions from the anolyte flow channel and of the protons from the catholyte flow channel.

### Example 9—Acid-Base DFC System

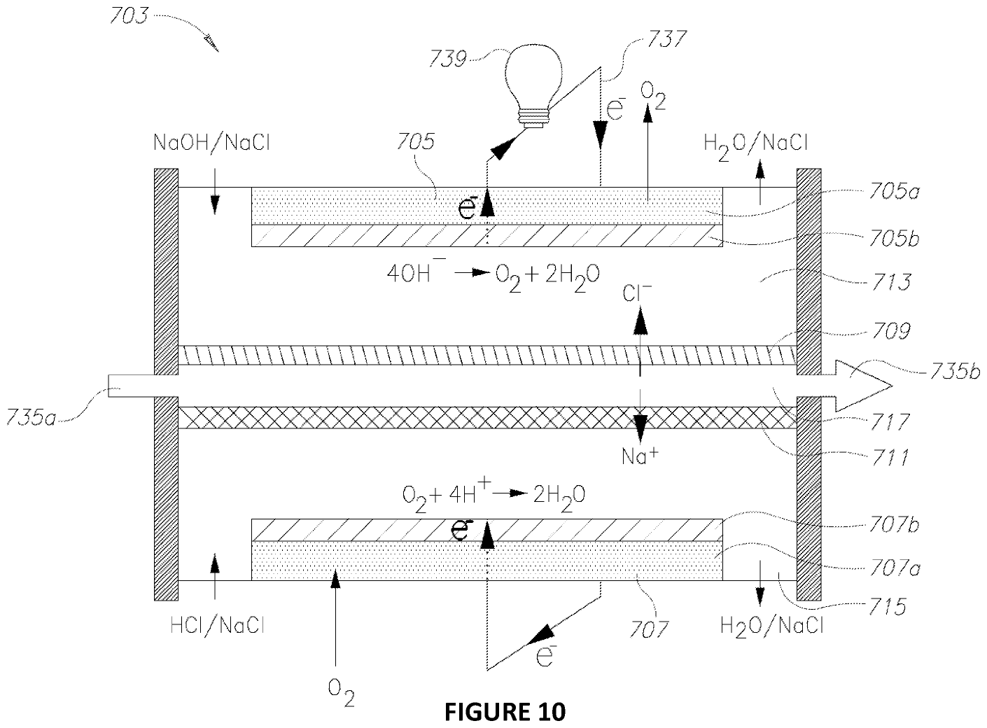

FIG. 10 schematically represents acid-base DFC 703, according to some embodiments of the invention. DFC 703 includes anode 705, which contains GDL 705a and catalytic layer 705b. DFC 703 further includes cathode 707, which contains GDL 707a and catalytic layer 707b. DFC 703 has a two-membrane design, including one AEM 709, one CEM 711, anolyte flow channel 713, catholyte flow channel 715, and one feedwater flow channel 717, similarly to DFC 303 shown in FIG. 3A. Anolyte contains hydroxyl ions (i.e., is alkaline). Oxygen, which is formed at anode 705 can be released through GDL 705a or returned to cathode 707. Catholyte contains hydronium ions (i.e., is acidic) and oxygen is flown to cathode 707 through GDL 707a. Anolyte flows through anolyte flow channel 713, as shown by arrows therewithin and catholyte flows through catholyte flow channel 715, as shown by arrows therewithin. Anode 705 and cathode 707 are electrically connected via electric circuit 737 including electric load 739 (direction of electrons flow is shown by arrows within electric circuit 737).

Increase in the overall charge of the species in anolyte flow channel 713 and catholyte flow channel 715, as a result of the acid-base cell redox reaction (Equations 7-9), induces ion migration throughout DFC 703. AEM 709 allows passage of negatively charged feedwater ions (e.g., Cl⁻ ions) from feedwater flow channel 717 to anolyte flow channel 713 and CEM 711 allows passage of the positively charged feedwater ions (e.g., Na⁺ ions) from feedwater flow channel 717 to catholyte flow channel 715, therefore providing deionization of feedwater 735a to obtain desalted water 735b. Direction of flow of Cl⁻ ions is shown by arrow which traverses AEM 709 and direction of flow of Na⁺ ions is shown by arrow which traverses CEM 711.

While the reductant (hydroxide ion) is negatively charged and, theoretically, can pass AEM 709 and flow from anolyte flow channel 713, operational conditions of the cell can be adjusted such that its flow to feedwater flow channel 717 is kept to a minimum or completely prevented. The same applies to the oxidant (hydronium ion or proton), which is positively charged and, theoretically, can pass CEM 711 and flow from catholyte flow channel 715. Operational conditions of the cell can be adjusted such that the flow of the protons to feedwater flow channel 717 is kept to a minimum or completely prevented. Additionally, even if hydroxyl ions and protons flow to feedwater flow channel 717, they recombine in feedwater flow channel 717 in a neutralization reaction to form water and do not increase the ionic concentration of the feedwater effluent.

### Example 10—Construction of Acid-Base DFC System

Acid-base DFC contained a custom-milled planar graphite current collectors, 2 mg/cm² platinum black carbon cloth electrode (Fuel cell store, Texas, USA) at the cathode and anode sides, Viton rubber gaskets, and Neosepta ion exchange membranes (Neosepta AMX and CMX, Tokuyama, Japan). The endplates used were PVDF. The anolyte and catholyte flow channels were made by cutting 10.5 by 1.5 cm channels into 1 mm thick Viton rubber gaskets, and stacking two gaskets per flow channel (flow channel thickness was 2 mm), the desalination channel was cut into a single 1 mm Viton rubber gasket with the channel dimensions of 10.5 by 1.5 cm. Thus, the active area of our DFC used for current normalization was 15.75 cm². The graphite current collectors were machined to get flow-fields for the air to enter and leave the cell, some 1 mm diameter holes were etched along the active area. The cell was sealed with fourteen M4, 48 mm long stainless steel bolts, which were plastic wrapped to prevent internal short circuiting. The connection to an external load was made through tabs on the graphite current collectors.

The DFC system further included three storage tanks connected to the catholyte flow channel, the anolyte flow channel and the feedwater flow channel and three peristaltic pumps (Masterflex, Cole Parmer, USA), for the flow of the catholyte, anolyte and feedwater.

### Example 11—Operation of the DFC System

The hydrogen-oxygen DFC, which construction is detailed in Example 10, was operated as follows:

The anolyte was prepared by mixing sodium chloride and sodium hydroxide salts into deionized water to form 1 L of 0.1 M NaOH/0.5 M NaCl. For the catholyte, hydrochloric acid and sodium chloride salt were mixed into deionized water to form 1 L of 0.1 M HCl/0.5 M NaCl. The relatively large volume of anolyte and catholyte was chosen in order to maintain an approximately constant state of charge throughout a series of desalination experiments. The feedwater was prepared by adding NaCl to 30 mL of deionized water to create a 500 mM (29.22 g/L) NaCl solution. The cell was open to air, so it could enter and leave the cell freely.

All three solutions, including anolyte, catholyte and feedwater were recirculated through the cell using the peristaltic pumps at a flow rate of 1 mL/min for the feedwater and 1.5 mL/min for the anolyte and catholyte.

It is appreciated by persons skilled in the art that the present invention is not limited by what has been particularly shown and described hereinabove. Rather the scope of the present invention includes both combinations and sub-combinations of various features described hereinabove as well as variations and modifications. Therefore, the invention is not to be constructed as restricted to the particularly described embodiments, and the scope and concept of the invention will be more readily understood by references to the claims, which follow.

1. A method of deionization of a liquid, the method comprising:
passing feedwater to be deionized through a deionization fuel cell system comprising a deionization fuel cell (DFC) comprising
a cathode;
an anode; and
at least:
a first cation exchange membrane (CEM); and
a first anion exchange membrane (AEM), and
discharging the DFC to produce electricity and deionized liquid,
wherein the method does not include a step of charging the fuel cell prior to or following the discharge step.

2. The method according to claim 1, wherein the DFC is discharged at a current density of at least about 1 mA/cm².

3-5. (canceled)

6. The method according to claim 1, wherein the DFC comprises
a catholyte flow channel, being disposed adjacent to the cathode;
an anolyte flow channel, being disposed adjacent to the anode; and
a feedwater flow channel formed between the first CEM and the first AEM; and
wherein the method comprises a step of passing a catholyte through the catholyte flow channel and/or passing an anolyte through the anolyte flow channel,
wherein the catholyte comprises an oxidant and/or its reduction reaction product and the anolyte comprises a reductant and/or its oxidation reaction product.

7. The method according to claim 6, wherein the feedwater is continuously cycled through the feedwater flow channel, the catholyte is continuously cycled through the catholyte flow channel, and the anolyte is continuously cycled through the anolyte flow channel, and wherein the flow rate of the catholyte and/or the anolyte is at least two-fold higher than the flow rate of the feedwater; or wherein said oxidant and/or said reductant is present in the catholyte and/or the anolyte in an amount configured to allow reduction of the TDS content of the feedwater to below about 3000 ppm.

8-13. (canceled)

14. The method according to claim 6, wherein the DFC is a zinc-bromine fuel cell, wherein the catholyte is an aqueous solution comprising tribromide and sodium cations wherein the concentration of tribromide ranges from about 0.5 M to about 3 M, wherein the catholyte tank comprises at least about 0.5 liter of the catholyte, and wherein the anolyte is an aqueous solution comprising zinc cations and chloride anions.

15. (canceled)

16. The method according to claim 6, wherein the DFC is a hydrogen-oxygen fuel cell or an acid-base fuel cell and wherein the catholyte is an aqueous solution comprising HCl and NaCl and wherein the anolyte is an aqueous solution comprising NaOH and NaCl.

17-18. (canceled)

19. The method according to claim 1, wherein the feedwater comprises uncharged species and the method further comprises a step of inputting energy into the DFC system to ionize and/or radicalize said uncharged species in the feedwater, wherein said step is performed by applying to the DFC at least one of a high voltage, heat, sonication, and electromagnetic radiation.

20. A deionization fuel cell system, comprising:
(a) a deionization fuel cell (DFC) comprising:
a cathode;
an anode;
a catholyte flow channel;
an anolyte flow channel, and
at least:
a first cation exchange membrane (CEM);
a first anion exchange membrane (AEM), and
a first feedwater flow channel, wherein:
the catholyte flow channel is disposed adjacent to the cathode,
the anolyte flow channel is disposed adjacent to the anode, and
the first feedwater flow channel is formed between the first CEM and the first AEM and is configured for the deionization of feedwater,
and
(b) at least one of a catholyte tank and an anolyte tank, the catholyte tank being operatively connected to the catholyte flow channel and the anolyte tank being operatively connected to the anolyte flow channel, wherein the catholyte tank comprises a catholyte comprising an oxidant and/or its reduction reaction product; and/or the anolyte tank comprises an anolyte comprising a reductant and/or its oxidation reaction product, wherein said oxidant and/or said reductant is present in the catholyte and/or the anolyte in an amount configured to allow reduction of the total dissolved solids (TDS) content of the feedwater to below about 3000 parts-per-million (ppm), wherein the fuel cell operates entirely in a discharge mode.

21. The system according to claim 20, wherein the DFC comprises:
(a) (n) CEMs and (n) AEMs, which form (2n—1) feedwater flow channels; or
(b) (n) CEMs and (n+1) AEMs, which form (2n) feedwater flow channels; or
(c) (n+1) CEMs and (n) AEMs, which form (2n) feedwater flow channels,
wherein (n≥1; and
wherein the catholyte flow channel is formed between the cathode and the first CEM and the anolyte flow channel is formed between the first AEM and the anode.

22. (canceled)

23. The system according to claim 20, wherein the oxidant is neutral or negatively charged and/or its reduction reaction product is negatively charged and wherein the reductant is neutral or positively charged and/or its oxidation reaction product is positively charged; or wherein the oxidant is positively charged and wherein the reductant is negatively charged, and wherein said positively charged oxidant and negatively charged reductant react to form a neutral non-ionic compound.

24. (canceled)

25. The system according to claim 20, wherein the DFC further comprises a second CEM and a second feedwater flow channel, wherein the catholyte flow channel is formed between the cathode and the first CEM; the anolyte flow channel is formed between the second CEM and the anode; and the second feedwater flow channel is formed between the first AEM and the second CEM and wherein the oxidant is neutral or negatively charged and/or its reduction reaction product is negatively charged and wherein the reductant is negatively charged and/or its oxidation reaction product is neutral or negatively charged.

26. (canceled)

27. The system according to claim 20, wherein the DFC further comprises a second CEM, a second AEM, a second feedwater flow channel, and a third feedwater flow channel, wherein the catholyte flow channel is formed between the cathode and the second AEM; the anolyte flow channel is formed between the second CEM and the anode; the second feedwater flow channel is formed between the first AEM and the second CEM; and the third feedwater flow channel is formed between the first CEM and the second AEM and wherein the oxidant is positively charged and/or its reduction reaction product is neutral or positively charged and wherein the reductant is negatively charged and/or its oxidation reaction product is neutral or negatively charged.

28-29. (canceled)

30. The system according to claim 20, wherein the cathode, the anode or both are selected from the group consisting of graphite, carbon, metal, metal carbide, metal nitride, metal oxide, polymer, and any combination thereof and/or wherein the first AEM, the second AEM, the first CEM, the second CEM, or any combination thereof is selected from the group consisting of an ion-selective polymeric membrane, ion-selective ceramic separator, ion-selective zeolite separator, and ion-selective glass separator.

31-34. (canceled)

35. The system according to claim 20, wherein the DFC is selected from the group consisting of zinc-bromine fuel cell, air-breathing aqueous sulfur fuel cell, oxygen-sulfur fuel cell, iron-sulfur fuel cell, hydrogen-oxygen fuel cell, acid-base fuel cell, and iodine-vanadium fuel cell.

36. The system according to claim 35, wherein the DFC is a zinc-bromine fuel cell.

37. (canceled)

38. The system according to claim 35, wherein the DFC is a hydrogen-oxygen fuel cell or an acid-base fuel cell, wherein the catholyte is an aqueous solution comprising HCl and NaCl and wherein the anolyte is an aqueous solution comprising NaOH and NaCl.

39-41. (canceled)

42. A deionization fuel cell system, comprising:
(a) a deionization fuel cell (DFC) comprising:
a cathode;
an anode;
a catholyte flow channel;
an anolyte flow channel;
a cation exchange membrane (CEM);
an anion exchange membrane (AEM); and
a feedwater flow channel,
wherein:
the catholyte flow channel is disposed between the cathode and the CEM,
the anolyte flow channel is disposed between the anode and the AEM, and
the feedwater flow channel is disposed between the CEM and the AEM,
and
(b) a catholyte tank being operatively connected to the catholyte flow channel and an anolyte tank being operatively connected to the anolyte flow channel, wherein
the catholyte tank comprises a catholyte comprising an oxidant comprising hydronium ions, and
the anolyte tank comprises an anolyte comprising a reductant comprising hydroxyl ions.

43. The system according to claim 42, wherein the DFC is a hydrogen-oxygen DFC, wherein the oxidant further comprises oxygen gas being supplied to the cathode and the reductant further comprises hydrogen gas being supplied to the anode; or wherein the DFC is an acid-base DFC, wherein the oxidant further comprises oxygen gas being supplied to the cathode.

44. (canceled)

45. The system according to claim 42, wherein the catholyte is an aqueous solution comprising HCl and an alkali metal or alkaline earth metal salt and wherein the anolyte is an aqueous solution comprising NaOH and an alkali metal or alkaline earth metal salt; and wherein the concentration of HCl in the catholyte ranges from about 0.1 mM to about 0.5 M, the concentration of NaOH in the anolyte ranges from about 0.1 mM to about 0.5 M, and the concentration of the alkali metal or alkaline earth metal salt is at least about 5 times higher than the concentration of each of the HCl and NaOH.

46-47. (canceled)

48. A method of deionization of a liquid, the method comprising:
a) passing feedwater to be deionized through the system according to claim 42, wherein the feedwater is continuously cycled through the first feedwater flow channel, the catholyte is continuously cycled through the catholyte flow channel and the anolyte is continuously cycled through the anolyte flow channel,
b) flowing oxygen gas to the cathode, and, optionally, flowing hydrogen gas to the anode, and
c) discharging the DFC to produce electricity and deionized liquid.

49-50. (canceled)
